(19) United States
(12) Patent Application Publication
(10) Pub. No.: US 2021/0002308 A1
(43) Pub. Date: Jan. 7, 2021

(54) SILICON-TERMINATED ORGANO-METAL COMPOUNDS AND PROCESSES FOR PREPARING THE SAME

(71) Applicant: Dow Global Technologies LLC, Midland, MI (US)

(72) Inventors: Lixin Sun, Sugar Land, TX (US); Phillip D. Hustad, St. Paul, MN (US)

(21) Appl. No.: 16/982,516

(22) PCT Filed: Mar. 18, 2019
(86) PCT No.: PCT/US2019/022784

§ 371 Date: Sep. 18, 2020

Related U.S. Application Data
(60) Provisional application No. 62/644,654, filed on Mar. 19, 2018.

(51) Int. Cl. C07F 7/08; C07F 3/02; C07F 3/04; C07F 3/06

(52) U.S. Cl. CPC C07F 7/0803; C07F 3/06; C07F 3/04; C07F 3/02

(57) ABSTRACT

The present disclosure is directed to a silicon-terminated organo-metal composition comprising a compound of formula (I). Embodiments relate to a process for preparing the silicon-terminated organo-metal composition comprising the compound of formula (I), the process comprising combining starting materials comprising (A) a vinyl-terminated silicon-based compound, (B) a chain shuttling agent, (C) a procatalyst, and (D) an activator, thereby obtaining a product comprising the silicon-terminated organo-metal composition. In further embodiments, the starting materials of the process may further comprise (E) a solvent and/or (F) a scavenger.

### CROSS-REFERENCE TO RELATED APPLICATIONS

The present application claims the benefit of priority to U.S. provisional patent application No. 62/644,654, filed on Mar. 19, 2018, and is hereby incorporated by reference in its entirety.

### FIELD

Embodiments relate to silicon-terminated organo-metal compositions and processes for preparing the same.

### BACKGROUND

In recent years, advances in polymer design have been seen with the use of compositions capable of chain shuttling and/or chain transfer. For example, chain shuttling agents having reversible or partial reversible chain transfer ability with transition metal catalysts have enabled the production of novel olefin block copolymers (OBCs). Typical compositions capable of chain shuttling and/or chain transfer are simple metal alkyls, such as diethyl zinc and triethyl aluminum. Upon polymerization of a chain shuttling agent, polymeryl-metal intermediates can be produced, including but not limited to compounds having the formula Q₂Zn or Q₃Al, with Q being an oligo- or polymeric substituent. These polymeryl-metal intermediates can enable the synthesis of novel end-functional polyolefins, including novel silicon-terminated organo-metal compositions.

### SUMMARY

In certain embodiments, the present disclosure relates to a silicon-terminated organo-metal composition comprising a compound of formula (I):

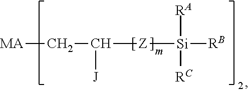

wherein:

MA is a divalent metal selected from the group consisting of Zn, Mg, and Ca;

each Z is independently a substituted or unsubstituted divalent C₁ to C₂₀ hydrocarbyl group that is linear, branched, or cyclic;

each subscript m is a number from 1 to 100,000;

each J is independently a hydrogen atom or a monovalent C₁ to C₂₀ hydrocarbyl group;

each R^{A}, R^{B}, and R^{C} is independently a hydrogen atom, a substituted or unsubstituted C₁ to C₁₀ monovalent hydrocarbyl group that is linear, branched, or cyclic, a vinyl group, an alkoxy group, or one or more siloxy units selected from M, D, and T units:

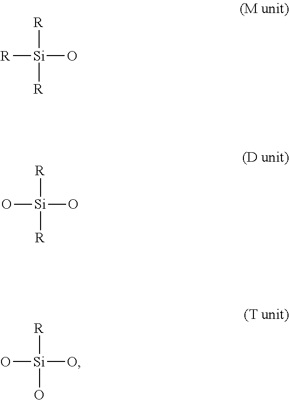

wherein each R is independently a hydrogen atom, a substituted or unsubstituted C₁ to C₁₀ monovalent hydrocarbyl group that is linear, branched, or cyclic, a vinyl group, or an alkoxy group;

two or all three of R^{A}, R^{B}, and R^{C} of one silicon atom may optionally be bonded together to form a ring structure when two or all three of R^{A}, R^{B}, and R^{C} of one silicon atom are each independently one or more siloxy units selected from D and T units.

In certain embodiments, the present disclosure relates to a process for preparing a silicon-terminated organo-metal composition comprising combining starting materials comprising:

(A) a vinyl-terminated silicon-based compound;

(B) a chain shuttling agent;

(C) a procatalyst, and

(D) an activator, thereby obtaining a product comprising the silicon-terminated organo-metal composition.

In certain embodiments, the starting materials of the process may further comprise optional materials, such as (E) a solvent, and (F) a scavenger.

### BRIEF DESCRIPTION OF DRAWINGS

FIGS. 1, 3 and 5 provide NMR spectra for the examples.

FIGS. 2 and 4 provide GCMS spectra for the examples.

### DETAILED DESCRIPTION

The present disclosure is directed to a silicon-terminated organo-metal composition and a process for preparing the same. The process comprises 1) combining starting materials comprising (A) a vinyl-terminated silicon-based compound, (B) a chain shuttling agent, (C) a procatalyst, and (D) an activator. In further embodiments, the starting materials of the process may further comprise (E) a solvent and/or (F) a scavenger.

Step 1) of combining the starting materials may be performed by any suitable means, such as mixing at a temperature of from 10° C. to 100° C., or from 20° C. to 60° C., or from 20° C. to 30° C., at ambient pressure. In certain embodiments, step 1) of combining the starting materials may be performed at room temperature. In certain embodiments, step 1) of combining the starting materials may be performed for a duration of from 30 minutes to 20 hours, or from 1 hour to 10 hours, or from 1 hour to 5 hours, or from 1 hour to 3 hours. In further embodiments, step 1) of combining the starting materials may be performed by solution processing (i.e., dissolving and/or dispersing the starting materials in a solvent). The amount of each starting material depends on various factors, including the specific selection of each starting material.

The process may optionally further comprise one or more additional steps. For example, the process may further comprise: 2) recovering the silicon-terminated organo-metal composition. Recovering may be performed by any suitable means, such as precipitation and filtration, thereby removing unwanted materials.

### (A) Vinyl-Terminated Silicon-Based Compound

Starting material (A) of the present process may be a vinyl-terminated silicon-based compound having the formula (II):

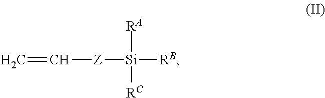

wherein:

Z is a substituted or unsubstituted divalent C₁ to C₂₀ hydrocarbyl group that is linear, branched, or cyclic;

R^{A}, R^{B}, and R^{C} are each independently a hydrogen atom, a substituted or unsubstituted C₁ to C₁₀ monovalent hydrocarbyl group that is linear, branched, or cyclic, a vinyl group, an alkoxy group, or one or more siloxy units selected from M, D, and T units:

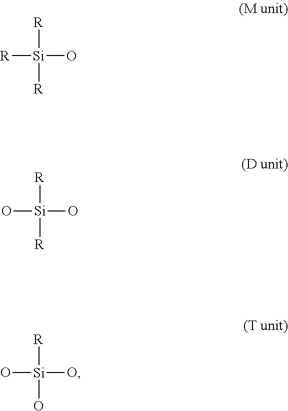

wherein each R is independently a hydrogen atom, a substituted or unsubstituted C₁ to C₁₀ monovalent hydrocarbyl group that is linear, branched, or cyclic, a vinyl group, or an alkoxy group; and

two or all three of R^{A}, R^{B}, and R^{C} may optionally be bonded together to form a ring structure when two or all three of R^{A}, R^{B}, and R^{C} are each independently one or more siloxy units selected from D and T units.

In certain embodiments of the vinyl-terminated silicon-based compound having the formula (II), at least one of R^{A}, R^{B}, and R^{C} is a hydrogen atom or a vinyl group. In further embodiments, each of at least two of R^{A}, R^{B}, and R^{C} is a linear C₁ to C₁₀ monovalent hydrocarbyl group, such as a methyl group. In further embodiments, Z is an unsubstituted divalent C₁ to C₂₀ hydrocarbyl group that is linear or branched.

Suitable vinyl-terminated silicon-based compounds include but are not limited to 7-octenyldimethylsilane, 7-octenyldimethylvinylsilane, and the like.

### (B) Chain Shuttling Agent

Starting material (B) of the present process may be a chain shuttling agent having the formula Y₂MA, where MA may be a divalent metal atom, and each Y is independently a hydrocarbyl group of 1 to 20 carbon atoms. In certain embodiments, MA may be but is not limited to Zn, Mg, or Ca. In further embodiments, MA may be Zn. The monovalent hydrocarbyl group of 1 to 20 carbon atoms may be alkyl group exemplified by ethyl, propyl, octyl, and combinations thereof. Suitable chain shuttling agents include those disclosed in U.S. Pat. Nos. 7,858,706 and 8,053,529, which are hereby incorporated by reference.

Suitable chain shuttling agents include but are not limited to dimethyl zinc, diethyl zinc, dipropyl zinc, dibutyl zinc, diisobutyl zinc, dihexyl zinc, diisohexyl zinc, dioctyl zinc, diisooctyl zinc, dimethyl magnesium, diethyl magnesium, dipropyl magnesium, dibutyl magnesium, diisobutyl magnesium, dihexyl magnesium, diisohexyl magnesium, dioctyl magnesium, and diisooctyl magnesium.

### (C) Procatalyst

Starting material (C) of the present process may be a procatalyst. Suitable procatalysts include any compound or combination of compounds capable of, when combined with an activator, polymerization of unsaturated monomers. Suitable procatalysts include but are not limited to those disclosed in WO 2005/090426, WO 2005/090427, WO 2007/035485, WO 2009/012215, WO 2014/105411, WO 2017/173080, U.S. Patent Publication Nos. 2006/0199930, 2007/0167578, 2008/0311812, and U.S. Pat. Nos. 7,355,089 B2, 8,058,373 B2, and 8,785,554 B2.

With reference to the paragraphs below, the terms “procatalysts,” “transition metal catalysts,” “transition metal catalyst precursors,” “catalysts,” “catalyst precursors,” “polymerization catalysts or catalyst precursors,”” “metal complexes,” “complexes,” “metal-ligand complexes,” and like terms are to be interchangeable.

Furthermore, any nomenclature of atoms or substituents (for example, M, X, Z, Y, etc.) in connection with the (C) procatalyst is distinct from the nomenclature (for example, MA, J, Z, m, R^{A}, R^{B}, R^{C}, Y) for the silicon-terminated organo-metal composition of formula (I), the vinyl-terminated silicon-based compound of formula (II), and the chain shuttling agent of Y₂MA

Both heterogeneous and homogeneous catalysts may be employed. Examples of heterogeneous catalysts include the well known Ziegler-Natta compositions, especially Group 4 metal halides supported on Group 2 metal halides or mixed halides and alkoxides and the well known chromium or vanadium based catalysts. Preferably, the catalysts for use herein are homogeneous catalysts comprising a relatively pure organometallic compound or metal complex, especially compounds or complexes based on metals selected from Groups 3-10 or the Lanthanide series of the Periodic Table of the Elements.

Metal complexes for use herein may be selected from Groups 3 to 15 of the Periodic Table of the Elements containing one or more delocalized, π-bonded ligands or polyvalent Lewis base ligands. Examples include metallocene, half-metallocene, constrained geometry, and polyvalent pyridylamine, or other polychelating base complexes. The complexes are generically depicted by the formula: MKₖXₓZ_{z}, or a dimer thereof, wherein

M is a metal selected from Groups 3-15, preferably 3-10, more preferably 4-10, and most preferably Group 4 of the Periodic Table of the Elements;
K independently at each occurrence is a group containing delocalized π-electrons or one or more electron pairs through which K is bound to M, said K group containing up to 50 atoms not counting hydrogen atoms, optionally two or more K groups may be joined together forming a bridged structure, and further optionally one or more K groups may be bound to Z, to X or to both Z and X;
X independently at each occurrence is a monovalent, anionic moiety having up to 40 non-hydrogen atoms, optionally one or more X groups may be bonded together thereby forming a divalent or polyvalent anionic group, and, further optionally, one or more X groups and one or more Z groups may be bonded together thereby forming a moiety that is both covalently bound to M and coordinated thereto; or two X groups together form a divalent anionic ligand group of up to 40 non-hydrogen atoms or together are a conjugated diene having from 4 to 30 non-hydrogen atoms bound by means of delocalized i-electrons to M, whereupon M is in the +2 formal oxidation state, and
Z independently at each occurrence is a neutral, Lewis base donor ligand of up to 50 non-hydrogen atoms containing at least one unshared electron pair through which Z is coordinated to M;
k is an integer from 0 to 3; x is an integer from 1 to 4; z is a number from 0 to 3; and the sum, k+x, is equal to the formal oxidation state of M.

Suitable metal complexes include those containing from 1 to 3 π-bonded anionic or neutral ligand groups, which may be cyclic or non-cyclic delocalized π-bonded anionic ligand groups. Exemplary of such π-bonded groups are conjugated or nonconjugated, cyclic or non-cyclic diene and dienyl groups, allyl groups, boratabenzene groups, phosphole, and arene groups. By the term “π-bonded” is meant that the ligand group is bonded to the transition metal by a sharing of electrons from a partially delocalized π-bond.

Each atom in the delocalized n-bonded group may independently be substituted with a radical selected from the group consisting of hydrogen, halogen, hydrocarbyl, halohydrocarbyl, hydrocarbyl-substituted heteroatoms wherein the heteroatom is selected from Group 14-16 of the Periodic Table of the Elements, and such hydrocarbyl-substituted heteroatom radicals further substituted with a Group 15 or 16 hetero atom containing moiety. In addition two or more such radicals may together form a fused ring system, including partially or fully hydrogenated fused ring systems, or they may form a metallocycle with the metal. Included within the term “hydrocarbyl” are C₁₋₂₀ straight, branched and cyclic alkyl radicals, C₆₋₂₀ aromatic radicals, C₇₋₂₀ alkyl-substituted aromatic radicals, and C₇₋₂₀ aryl-substituted alkyl radicals. Suitable hydrocarbyl-substituted heteroatom radicals include mono-, di- and tri-substituted radicals of boron, silicon, germanium, nitrogen, phosphorus or oxygen wherein each of the hydrocarbyl groups contains from 1 to 20 carbon atoms. Examples include N,N-dimethylamino, pyrrolidinyl, trimethylsilyl, triethylsilyl, t-butyldimethylsilyl, methyldi(t-butyl)silyl, triphenylgermyl, and trimethylgermyl groups. Examples of Group 15 or 16 hetero atom containing moieties include amino, phosphino, alkoxy, or alkylthio moieties or divalent derivatives thereof, for example, amide, phosphide, alkyleneoxy or alkylenethio groups bonded to the transition metal or Lanthanide metal, and bonded to the hydrocarbyl group, π-bonded group, or hydrocarbyl-substituted heteroatom.

Examples of suitable anionic, delocalized π-bonded groups include cyclopentadienyl, indenyl, fluorenyl, tetrahydroindenyl, tetrahydrofluorenyl, octahydrofluorenyl, pentadienyl, cyclohexadienyl, dihydroanthracenyl, hexahydroanthracenyl, decahydroanthracenyl groups, phosphole, and boratabenzyl groups, as well as inertly substituted derivatives thereof, especially C₁₋₁₀ hydrocarbyl-substituted or tris(C₁₋₁₀ hydrocarbyl)silyl-substituted derivatives thereof. Preferred anionic delocalized π-bonded groups are cyclopentadienyl, pentamethylcyclopentadienyl, tetramethylcyclopentadienyl, tetramethylsilylcyclopentadienyl, indenyl, 2,3-dimethylindenyl, fluorenyl, 2-methylindenyl, 2-methyl-4-phenylindenyl, tetrahydrofluorenyl, octahydrofluorenyl, 1-indacenyl, 3-pyrrolidinoinden-1-yl, 3,4-(cyclopenta(l)phenanthren-1-yl, and tetrahydroindenyl.

The boratabenzenyl ligands are anionic ligands which are boron containing analogues to benzene. They are previously known in the art having been described by G. Herberich, et al., in Organometallics, 14, 1, 471-480 (1995). Preferred boratabenzenyl ligands correspond to the formula:

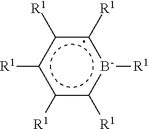

wherein R¹ is an inert substituent, preferably selected from the group consisting of hydrogen, hydrocarbyl, silyl, halo or germyl, said R¹ having up to 20 atoms not counting hydrogen, and optionally two adjacent R¹ groups may be joined together. In complexes involving divalent derivatives of such delocalized π-bonded groups one atom thereof is bonded by means of a covalent bond or a covalently bonded divalent group to another atom of the complex thereby forming a bridged system.

Phospholes are anionic ligands that are phosphorus containing analogues to a cyclopentadienyl group. They are previously known in the art having been described by WO 98/50392, and elsewhere. Preferred phosphole ligands correspond to the formula:

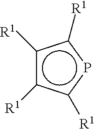

wherein R¹ is as previously defined.
Suitable transition metal complexes for use herein correspond to the formula: MKₖXₓZ_{z}, or a dimer thereof, wherein:
M is a Group 4 metal;
K is a group containing delocalized π-electrons through which K is bound to M, said K group containing up to 50 atoms not counting hydrogen atoms, optionally two K groups may be joined together forming a bridged structure, and further optionally one K may be bound to X or Z;
X at each occurrence is a monovalent, anionic moiety having up to 40 non-hydrogen atoms, optionally one or more X and one or more K groups are bonded together to form a metallocycle, and further optionally one or more X and one or more Z groups are bonded together thereby forming a moiety that is both covalently bound to M and coordinated thereto;
Z independently at each occurrence is a neutral, Lewis base donor ligand of up to 50 non-hydrogen atoms containing at least one unshared electron pair through which Z is coordinated to M;
k is an integer from 0 to 3; x is an integer from 1 to 4; z is a number from 0 to 3; and the sum, k+x, is equal to the formal oxidation state of M.

Suitable complexes include those containing either one or two K groups. The latter complexes include those containing a bridging group linking the two K groups. Suitable bridging groups are those corresponding to the formula (ER′₂)ₑ wherein E is silicon, germanium, tin, or carbon, R′ independently at each occurrence is hydrogen or a group selected from silyl, hydrocarbyl, hydrocarbyloxy and combinations thereof, said R′ having up to 30 carbon or silicon atoms, and e is 1 to 8. Illustratively, R′ independently at each occurrence is methyl, ethyl, propyl, benzyl, tert-butyl, phenyl, methoxy, ethoxy or phenoxy.

Examples of the complexes containing two K groups are compounds corresponding to the formula:

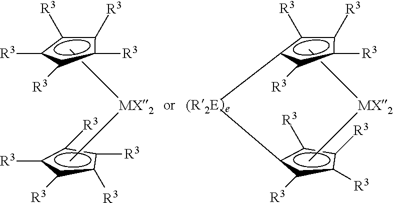

wherein:
M is titanium, zirconium or hafnium, preferably zirconium or hafnium, in the +2 or +4 formal oxidation state; R³ at each occurrence independently is selected from the group consisting of hydrogen, hydrocarbyl, silyl, germyl, cyano, halo and combinations thereof, said R³ having up to 20 non-hydrogen atoms, or adjacent R³ groups together form a divalent derivative (that is, a hydrocarbadiyl, siladiyl or germadiyl group) thereby forming a fused ring system, and X″ independently at each occurrence is an anionic ligand group of up to 40 non-hydrogen atoms, or two X″ groups together form a divalent anionic ligand group of up to 40 non-hydrogen atoms or together are a conjugated diene having from 4 to 30 non-hydrogen atoms bound by means of delocalized π-electrons to M, whereupon M is in the +2 formal oxidation state, and
R′, E and e are as previously defined.

Exemplary bridged ligands containing two π-bonded groups are: dimethylbis(cyclopentadienyl)silane, dimethylbis(tetramethylcyclopentadienyl)silane, dimethylbis(2-ethylcyclopentadien-1-yl)silane, dimethylbis(2-t-butylcyclopentadien-1-yl)silane, 2,2-bis(tetramethylcyclopentadienyl)propane, dimethylbis(inden-1-yl)silane, dimethylbis(tetrahydroinden-1-yl)silane, dimethylbis(fluoren-1-yl)silane, dimethylbis(tetrahydrofluoren-1-yl)silane, dimethylbis(2-methyl-4-phenylinden-1-yl)-silane, dimethylbis(2-methylinden-1-yl)silane, dimethyl(cyclopentadienyl)(fluoren-1-yl)silane, dimethyl(cyclopentadienyl)(octahydrofluoren-1-yl)silane, dimethyl(cyclopentadienyl)(tetrahydrofluoren-1-yl)silane, (1,1,2,2-tetramethy)-1,2-bis(cyclopentadienyl)disilane, (1,2-bis(cyclopentadienyl)ethane, and dimethyl(cyclopentadienyl)-1-(fluoren-1-yl)methane.

Suitable X″ groups are selected from hydride, hydrocarbyl, silyl, germyl, halohydrocarbyl, halosilyl, silylhydrocarbyl and aminohydrocarbyl groups, or two X″ groups together form a divalent derivative of a conjugated diene or else together they form a neutral, π-bonded, conjugated diene. Exemplary X″ groups are C1-20 hydrocarbyl groups.

Examples of metal complexes of the foregoing formula suitable for use in the present disclosure include:
bis(cyclopentadienyl)zirconiumdimethyl,
bis(cyclopentadienyl)zirconium dibenzyl,
bis(cyclopentadienyl)zirconium methyl benzyl,
bis(cyclopentadienyl)zirconium methyl phenyl, bis(cyclopentadienyl)zirconiumdiphenyl,
bis(cyclopentadienyl)titanium-allyl,
bis(cyclopentadienyl)zirconiummethylmethoxide,
bis(cyclopentadienyl)zirconiummethylchloride,
bis(pentamethylcyclopentadienyl)zirconiumdimethyl,
bis(pentamethylcyclopentadienyl)titaniumdimethyl,
bis(indenyl)zirconiumdimethyl,
indenylfluorenylzirconiumdimethyl,
bis(indenyl)zirconiummethyl(2-(dimethylamino)benzyl),
bis(indenyl)zirconiummethyltrimethylsilyl,
bis(tetrahydroindenyl)zirconiummethyltrimethylsilyl,
bis(pentamethylcyclopentadienyl)zirconiummethylbenzyl,
bis(pentamethylcyclopentadienyl)zirconiumdibenzyl,
bis(pentamethylcyclopentadienyl)zirconiummethylmethoxide,
bis(pentamethylcyclopentadienyl)zirconiummethylchloride,
bis(methylethylcyclopentadienyl)zirconiumdimethyl,
bis(butylcyclopentadienyl)zirconiumdibenzyl,
bis(t-butylcyclopentadienyl)zirconiumdimethyl,
bis(ethyltetramethylcyclopentadienyl)zirconiumdimethyl,
bis(methylpropylcyclopentadienyl)zirconiumdibenzyl,
bis(trimethylsilylcyclopentadienyl)zirconiumdibenzyl,
dimethylsilylbis(cyclopentadienyl)zirconiumdichloride,
dimethylsilylbis(cyclopentadienyl)zirconiumdimethyl,
dimethylsilylbis(tetramethylcyclopentadienyl)titanium (III) allyl
dimethylsilylbis(t-butylcyclopentadienyl)zirconiumdichloride,
dimethylsilylbis(n-butylcyclopentadienyl)zirconiumdichloride,
(dimethylsilylbis(tetramethylcyclopentadienyl)titanium(III) 2-(dimethylamino)benzyl,
(dimethylsilylbis(n-butylcyclopentadienyl)titanium(III) 2-(dimethylamino)benzyl,
dimethylsilylbis(indenyl)zirconiumdichloride, dimethylsilylbis(indenyl)zirconiumdimethyl,
dimethylsilylbis(2-methylindenyl)zirconiumdimethyl,
dimethylsilylbis(2-methyl-4-phenylindenyl)zirconiumdimethyl,
dimethylsilylbis(2-methylindenyl)zirconium-1,4-diphenyl-1,3-butadiene, dimethylsilylbis(2-methyl-4-phenylindenyl)zirconium (II) 1,4-diphenyl-1,3-butadiene,
dimethylsilylbis(4,5,6,7-tetrahydroinden-1-yl)zirconiumdichloride, dimethylsilylbis(4,5,6,7-tetrahydroinden-1-yl)zirconiumdimethyl, dimethylsilylbis(tetrahydroindenyl)zirconium(II)
1,4-diphenyl-1,3-butadiene, dimethylsilylbis(tetramethylcyclopentadienyl)zirconium dimethyl, dimethylsilylbis(fluorenyl)zirconiumdimethyl,
dimethylsilylbis(tetrahydrofluorenyl)zirconium bis(trimethylsilyl),
ethylenebis(indbnyl)zirconiumdichloride,
ethylenebis(indenyl)zirconiumdimethyl,
ethylenebis(4,5,6,7-tetrahydroindenyl)zirconiumdichloride,
ethylenebis(4,5,6,7-tetrahydroindenyl)zirconiumdimethyl,
(isopropylidene)(cyclopentadienyl)(fluorenyl)zirconiumdibenzyl, and
dimethylsilyl(tetramethylcyclopentadienyl)(fluorenyl)zirconium dimethyl.

A further class of metal complexes utilized in the present disclosure corresponds to the preceding formula: MKZ_{z}Xₓ, or a dimer thereof, wherein M, K, X, x and z are as previously defined, and Z is a substituent of up to 50 non-hydrogen atoms that together with K forms a metallocycle with M.

Suitable Z substituents include groups containing up to 30 non-hydrogen atoms comprising at least one atom that is oxygen, sulfur, boron or a member of Group 14 of the Periodic Table of the Elements directly attached to K, and a different atom, selected from the group consisting of nitrogen, phosphorus, oxygen or sulfur that is covalently bonded to M.

More specifically this class of Group 4 metal complexes used according to the present invention includes “constrained geometry catalysts” corresponding to the formula:

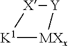

wherein: M is titanium or zirconium, preferably titanium in the +2, +3, or +4 formal oxidation state;
K¹ is a delocalized, π-bonded ligand group optionally substituted with from 1 to 5 R² groups, R² at each occurrence independently is selected from the group consisting of hydrogen, hydrocarbyl, silyl, germyl, cyano, halo and combinations thereof, said R² having up to 20 non-hydrogen atoms, or adjacent R² groups together form a divalent derivative (that is, a hydrocarbadiyl, siladiyl or germadiyl group) thereby forming a fused ring system, each X is a halo, hydrocarbyl, heterohydrocarbyl, hydrocarbyloxy or silyl group, said group having up to 20 non-hydrogen atoms, or two X groups together form a neutral C5-30 conjugated diene or a divalent derivative thereof;
x is 1 or 2;

### Y is —O—, —S—, —NR′—, —PR′—;

and X′ is SiR′₂, CR′₂, SiR′₂SiR′₂, CR′₂CR′₂, CR′═CR′, CR′₂SiR′₂, or GeR′₂, wherein
R′ independently at each occurrence is hydrogen or a group selected from silyl, hydrocarbyl, hydrocarbyloxy and combinations thereof, said R′ having up to 30 carbon or silicon atoms.

Specific examples of the foregoing constrained geometry metal complexes include compounds corresponding to the formula:

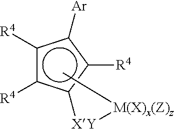

wherein,
Ar is an aryl group of from 6 to 30 atoms not counting hydrogen;
R⁴ independently at each occurrence is hydrogen, Ar, or a group other than Ar selected from hydrocarbyl, trihydrocarbylsilyl, trihydrocarbylgermyl, halide, hydrocarbyloxy, trihydrocarbylsiloxy, bis(trihydrocarbylsilyl)amino, di(hydrocarbyl)amino, hydrocarbadiylamino, hydrocarbylimino, di(hydrocarbyl)phosphino, hydrocarbadiylphosphino, hydrocarbylsulfido, halo-substituted hydrocarbyl, hydrocarbyloxy-substituted hydrocarbyl, trihydrocarbylsilyl-substituted hydrocarbyl, trihydrocarbylsiloxy-substituted hydrocarbyl, bis(trihydrocarbylsilyl)amino-substituted hydrocarbyl, di(hydrocarbyl)amino-substituted hydrocarbyl, hydrocarbyleneamino-substituted hydrocarbyl, di(hydrocarbyl)phosphino-substituted hydrocarbyl, hydrocarbylenephosphino-substituted hydrocarbyl, or hydrocarbylsulfido-substituted hydrocarbyl, said R group having up to 40 atoms not counting hydrogen atoms, and optionally two adjacent R⁴ groups may be joined together forming a polycyclic fused ring group;
M is titanium;
X′ is SiR⁶₂, CR⁶₂, SiR⁶₂SiR⁶₂, CR⁶₂CR⁶₂, CR⁶═CR⁶, CR⁶₂SiR⁶₂, BR⁶, BR⁶L″, or GeR⁶₂;
Y is —O—, —S—, —NR⁵—, —PR⁵—; —NR⁵₂, or —PR⁵₂;
R⁵, independently at each occurrence is hydrocarbyl, trihydrocarbylsilyl, or trihydrocarbylsilylhydrocarbyl, said R⁵ having up to 20 atoms other than hydrogen, and optionally two R⁵ groups or R⁵ together with Y or Z form a ring system;
R⁶, independently at each occurrence, is hydrogen, or a member selected from hydrocarbyl, hydrocarbyloxy, silyl, halogenated alkyl, halogenated aryl, —NR⁵₂, and combinations thereof, said R⁶ having up to 20 non-hydrogen atoms, and optionally, two R⁶ groups or R⁶ together with Z forms a ring system;
Z is a neutral diene or a monodentate or polydentate Lewis base optionally bonded to R⁵, R⁶, or X;
X is hydrogen, a monovalent anionic ligand group having up to 60 atoms not counting hydrogen, or two X groups are joined together thereby forming a divalent ligand group;
x is 1 or 2; and
z is 0, 1 or 2.

Suitable examples of the foregoing metal complexes are substituted at both the 3- and 4-positions of a cyclopentadienyl or indenyl group with an Ar group. Examples of the foregoing metal complexes include:
(3-phenylcyclopentadien-1-yl)dimethyl(t-butylamido)silanetitanium dichloride,
(3-phenylcyclopentadien-1-yl)dimethyl(t-butylamido)silanetitanium dimethyl,
(3-phenylcyclopentadien-1-yl)dimethyl(t-butylamido)silanetitanium (II) 1,3-diphenyl-1,3-butadiene;
(3-(pyrrol-1-yl)cyclopentadien-1-yl)dimethyl(t-butylamido)silanetitanium dichloride,
(3-(pyrrol-1-yl)cyclopentadien-1-yl)dimethyl(t-butylamido)silanetitanium dimethyl,
(3-(pyrrol-1-yl)cyclopentadien-1-yl))dimethyl(t-butylamido)silanetitanium (II) 1,4-diphenyl-1,3-butadiene;
(3-(1-methylpyrrol-3-yl)cyclopentadien-1-yl)dimethyl(t-butylamido)silanetitanium dichloride,
(3-(1-methylpyrrol-3-yl)cyclopentadien-1-yl)dimethyl(t-butylamido)silanetitanium dimethyl,
(3-(1-methylpyrrol-3-yl)cyclopentadien-1-yl)dimethyl(t-butylamido)silanetitanium (II) 1,4-diphenyl-1,3-butadiene;
(3,4-diphenylcyclopentadien-1-yl)dimethyl(t-butylamido)silanetitanium dichloride,
(3,4-diphenylcyclopentadien-1-yl)dimethyl(t-butylamido)silanetitanium dimethyl,
(3,4-diphenylcyclopentadien-1-yl)dimethyl(t-butylamido)silanetitanium (1) 1,3-pentadiene;
(3-(3-N,N-dimethylamino)phenyl)cyclopentadien-1-yl)dimethyl(t-butylamido)silanetitanium dichloride,
(3-(3-N,N-dimethylamino)phenylcyclopentadien-1-yl)dimethyl(t-butylamido)silanetitanium dimethyl,
(3-(3-N,N-dimethylamino)phenylcyclopentadien-1-yl)dimethyl(t-butylamido)silanetitanium (II) 1,4-diphenyl-1,3-butadiene;
(3-(4-methoxyphenyl)-4-methylcyclopentadien-1-yl)dimethyl(t-butylamido)silanetitanium dichloride,
(3-(4-methoxyphenyl)-4-phenylcyclopentadien-1-yl)dimethyl(t-butylamido)silanetitanium dimethyl,
(3-4-methoxyphenyl)-4-phenylcyclopentadien-1-yl)dimethyl(t-butylamido)silanetitanium (II)
1,4-diphenyl-1,3-butadiene;
(3-phenyl-4-methoxycyclopentadien-1-yl)dimethyl(t-butylamido)silanetitanium dichloride,
(3-phenyl-4-methoxycyclopentadien-1-yl)dimethyl(t-butylamido)silanetitanium dimethyl,
(3-phenyl-4-methoxycyclopentadien-1-yl)dimethyl(t-butylamido)silanetitanium (II) 1,4-diphenyl-1,3-butadiene;
(3-phenyl-4-(N,N-dimethylamino)cyclopentadien-1-yl)dimethyl(t-butylamido)silanetitanium dichloride,
(3-phenyl-4-(N,N-dimethylamino)cyclopentadien-1-yl)dimethyl(t-butylamido)silanetitanium dimethyl,
(3-phenyl-4-(N,N-dimethylamino)cyclopentadien-1-yl)dimethyl(t-butylamido)silanetitanium (II) 1,4-diphenyl-1,3-butadiene;
2-methyl-(3,4-di(4-methylphenyl)cyclopentadien-1-yl)dimethyl(t-butylamido)silanetitanium dichloride,
2-methyl-(3,4-di(4-methylphenyl)cyclopentadien-1-yl)dimethyl(t-butylamido)silanetitanium dimethyl,
2-methyl-(3,4-di(4-methylphenyl)cyclopentadien-1-yl)dimethyl(t-butylamido)silanetitanium (II) 1,4-diphenyl-1,3-butadiene;
((2,3-diphenyl)-4-(N,N-dimethylamino)cyclopentadien-1-yl)dimethyl(t-butylamido)silane titanium dichloride,
((2,3-diphenyl)-4-(N,N-dimethylamino)cyclopentadien-1-yl)dimethyl(t-butylamido)silane titanium dimethyl,
((2,3-diphenyl)-4-(N,N-dimethylamino)cyclopentadien-1-yl)dimethyl(t-butylamido)silanetitanium (II) 1,4-diphenyl-1,3-butadiene;
(2,3,4-triphenyl-5-methylcyclopentadien-1-yl)dimethyl(t-butylamido)silanetitanium dichloride,
(2,3,4-triphenyl-5-methylcyclopentadien-1-yl)dimethyl(t-butylamido)silanetitanium dimethyl,
(2,3,4-triphenyl-5-methylcyclopentadien-1-yl)dimethyl(t-butylamido)silanetitanium (I) 1,4-diphenyl-1,3-butadiene;
(3-phenyl-4-methoxycyclopentadien-1-yl)dimethyl(t-butylamido)silanetitanium dichloride,
(3-phenyl-4-methoxycyclopentadien-1-yl)dimethyl(t-butylamido)silanetitanium dimethyl,
(3-phenyl-4-methoxycyclopentadien-1-yl)dimethyl(t-butylamido)silanetitanium (II) 1,4-diphenyl-1,3-butadiene;
(2,3-diphenyl-4-(n-butyl)cyclopentadien-1-yl)dimethyl(t-butylamido)silanetitanium dichloride,
(2,3-diphenyl-4-(n-butyl)cyclopentadien-1-yl)dimethyl(t-butylamido)silanetitanium dimethyl,
(2,3-diphenyl-4-(n-butyl)cyclopentadien-1-yl)dimethyl(t-butylamido)silanetitanium (I) 1,4-diphenyl-1,3-butadiene;
(2,3,4,5-tetraphenylcyclopentadien-1-yl)dimethyl(t-butylamido)silanetitanium dichloride,
(2,3,4,5-tetraphenylcyclopentadien-1-yl)dimethyl(t-butylamido)silanetitanium dimethyl, and
(2,3,4,5-tetraphenylcyclopentadien-1-yl)dimethyl(t-butylamido)silanetitanium (I) 1,4-diphenyl-1,3-butadiene.
Additional examples of suitable metal complexes herein are polycyclic complexes corresponding to the formula:

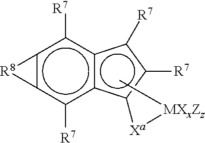

where M is titanium in the +2, +3 or +4 formal oxidation state;
R⁷ independently at each occurrence is hydride, hydrocarbyl, silyl, germyl, halide, hydrocarbyloxy, hydrocarbylsiloxy, hydrocarbylsilylamino, di(hydrocarbyl)amino, hydrocarbyleneamino, di(hydrocarbyl)phosphino, hydrocarbylene-phosphino, hydrocarbylsulfido, halo-substituted hydrocarbyl, hydrocarbyloxy-substituted hydrocarbyl, silyl-substituted hydrocarbyl, hydrocarbylsiloxy-substituted hydrocarbyl, hydrocarbylsilylamino-substituted hydrocarbyl, di(hydrocarbyl)amino-substituted hydrocarbyl, hydrocarbyleneamino-substituted hydrocarbyl, di(hydrocarbyl)phosphino-substituted hydrocarbyl, hydrocarbylene-phosphino-substituted hydrocarbyl, or hydrocarbylsulfido-substituted hydrocarbyl, said R⁷ group having up to 40 atoms not counting hydrogen, and optionally two or more of the foregoing groups may together form a divalent derivative;
R⁸ is a divalent hydrocarbylene- or substituted hydrocarbylene group forming a fused system with the remainder of the metal complex, said R⁸ containing from 1 to 30 atoms not counting hydrogen;
X^{a} is a divalent moiety, or a moiety comprising one σ-bond and a neutral two electron pair able to form a coordinate-covalent bond to M, said X^{a} comprising boron, or a member of Group 14 of the Periodic Table of the Elements, and also comprising nitrogen, phosphorus, sulfur or oxygen;
X is a monovalent anionic ligand group having up to 60 atoms exclusive of the class of ligands that are cyclic, delocalized, π-bound ligand groups and optionally two X groups together form a divalent ligand group;
Z independently at each occurrence is a neutral ligating compound having up to 20 atoms;
x is 0, 1 or 2; and
z is zero or 1.

Suitable examples of such complexes are 3-phenyl-substituted s-indecenyl complexes corresponding to the formula:

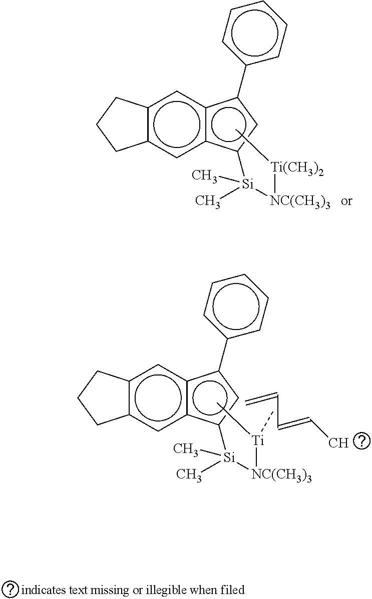

2,3-dimethyl-substituted s-indecenyl complexes corresponding to the formulas:

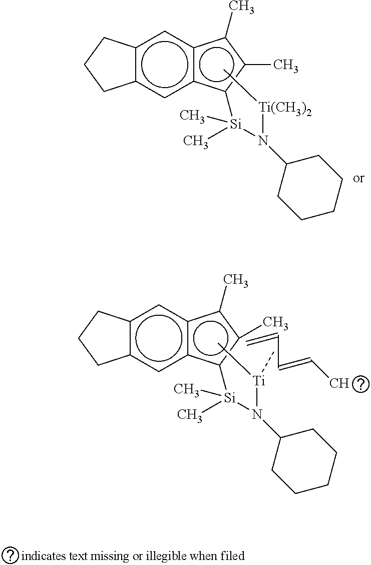

or 2-methyl-substituted s-indecenyl complexes corresponding to the formula:

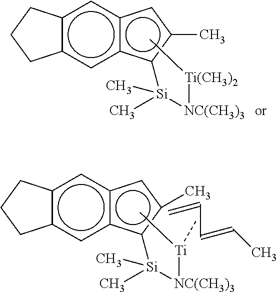

Additional examples of metal complexes that are usefully employed as catalysts according to the present invention include those of the formula:

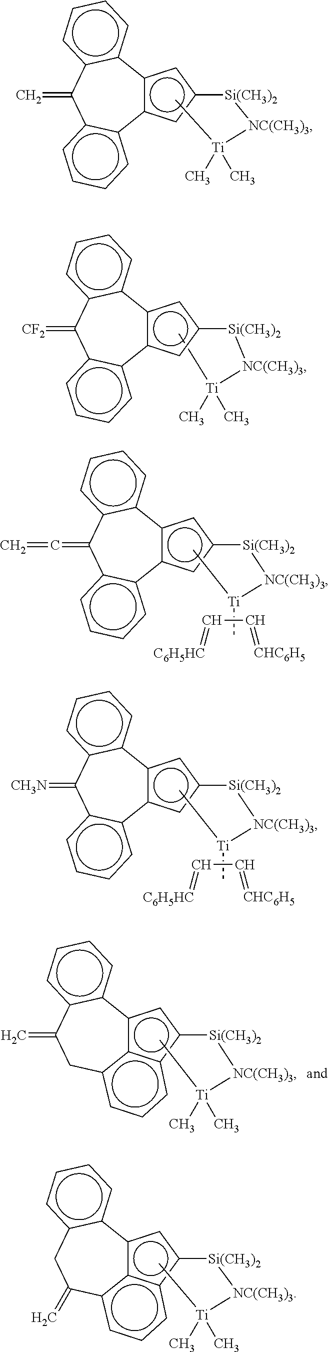

Specific metal complexes include:
(8-methylene-1,8-dihydrodibenzo[e,h]azulen-1-yl)-N-(1,1-dimethylethyl)dimethylsilanamide titanium (II) 1,4-diphenyl-1,3-butadiene,
(8-methylene-1,8-dihydrodibenzo[e,h]azulen-1-yl)-N-(1,1-dimethylethyl)dimethylsilanamide titanium (II) 1,3-pentadiene,
(8-methylene-1,8-dihydrodibenzo[e,h]azulen-1-yl)-N-(1,1-dimethylethyl)dimethylsilanamide titanium (III) 2-(N,N-dimethylamino)benzyl,
(8-methylene-1,8-dihydrodibenzo[e,h]azulen-1-yl)-N-(1,1-dimethylethyl)dimethylsilanamide titanium (IV) dichloride,
(8-methylene-1,8-dihydrodibenzo[e,h]azulen-1-yl)-N-(1,1-dimethylethyl)dimethylsilanamide titanium (IV) dimethyl,
(8-methylene-1,8-dihydrodibenzo[e,h]azulen-1-yl)-N-(1,1-dimethylethyl)dimethylsilanamide titanium (IV) dibenzyl,
(8-difluoromethylene-1,8-dihydrodibenzo[e,h]azulen-1-yl)-N-(1,1-dimethylethyl)dimethylsilanamide titanium (II) 1,4-diphenyl-1,3-butadiene,
(8-difluoromethylene-1,8-dihydrodibenzo[e,h]azulen-1-yl)-N-(1,1-dimethylethyl)dimethylsilanamide titanium (II) 1,3-pentadiene,
(8-difluoromethylene-1,8-dihydrodibenzo[e,h]azulen-1-yl)-N-(1,1-dimethylethyl)dimethylsilanamide titanium (III) 2-(N,N-dimethylamino)benzyl,
(8-difluoromethylene-1,8-dihydrodibenzo[e,h]azulen-1-yl)-N-(1,1-dimethylethyl)dimethylsilanamide titanium (IV) dichloride,
(8-difluoromethylene-1,8-dihydrodibenzo[e,h]azulen-1-yl)-N-(1,1-dimethylethyl)dimethylsilanamide titanium (IV) dimethyl,
(8-difluoromethylene-1,8-dihydrodibenzo[e,h]azulen-1-yl)-N-(1,1-dimethylethyl)dimethylsilanamide titanium (IV) dibenzyl,
(8-methylene-1,8-dihydrodibenzo[e,h]azulen-2-yl)-N-(1,1-dimethylethyl)dimethylsilanamide titanium (II) 1,4-diphenyl-1,3-butadiene,
(8-methylene-1,8-dihydrodibenzo[e,h]azulen-2-yl)-N-(1,1-dimethylethyl)dimethylsilanamide titanium (II) 1,3-pentadiene,
(8-methylene-1,8-dihydrodibenzo[e,h]azulen-2-yl)-N-(1,1-dimethylethyl)dimethylsilanamide titanium (III) 2-(N,N-dimethylamino)benzyl,
(8-methylene-1,8-dihydrodibenzo[e,h]azulen-2-yl)-N-(1,1-dimethylethyl)dimethylsilanamide titanium (IV) dichloride,
(8-methylene-1,8-dihydrodibenzo[e,h]azulen-2-yl)-N-(1,1-dimethylethyl)dimethylsilanamide titanium (IV) dimethyl,
(8-methylene-1,8-dihydrodibenzo[e,h]azulen-2-yl)-N-(1,1-dimethylethyl)dimethylsilanamide titanium (IV) dibenzyl,
(8-difluoromethylene-1,8-dihydrodibenzo[e,h]azulen-2-yl)-N-(1,1-dimethylethyl)dimethylsilanamide titanium (II) 1,4-diphenyl-1,3-butadiene,
(8-difluoromethylene-1,8-dihydrodibenzo[e,h]azulen-2-yl)-N-(1,1-dimethylethyl)dimethylsilanamide titanium (II) 1,3-pentadiene,
(8-difluoromethylene-1,8-dihydrodibenzo[e,h]azulen-2-yl)-N-(1,1-dimethylethyl)dimethylsilanamide titanium (III) 2-(N,N-dimethylamino)benzyl,
(8-difluoromethylene-1,8-dihydrodibenzo[e,h]azulen-2-yl)-N-(1,1-dimethylethyl)dimethylsilanamide titanium (IV) dichloride,
(8-difluoromethylene-1,8-dihydrodibenzo[e,h]azulen-2-yl)-N-(1,1-dimethylethyl)dimethylsilanamide titanium (IV) dimethyl,
(8-difluoromethylene-1,8-dihydrodibenzo[e,h]azulen-2-yl)-N-(1,1-dimethylethyl)dimethylsilanamide titanium (IV) dibenzyl, and mixtures thereof, especially mixtures of positional isomers.

Further illustrative examples of metal complexes for use according to the present invention correspond to the formula:

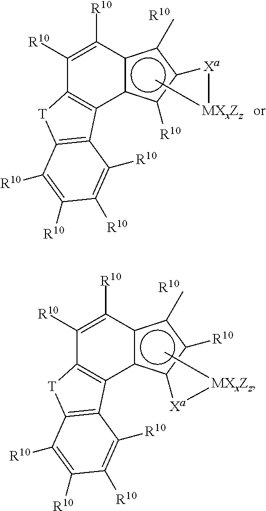

where M is titanium in the +2, +3 or +4 formal oxidation state;

### T is —NR⁹— or —O—;

R⁹ is hydrocarbyl, silyl, germyl, dihydrocarbylboryl, or halohydrocarbyl or up to 10 atoms not counting hydrogen;
R¹⁰ independently at each occurrence is hydrogen, hydrocarbyl, trihydrocarbylsilyl, trihydrocarbylsilylhydrocarbyl, germyl, halide, hydrocarbyloxy, hydrocarbylsiloxy, hydrocarbylsilylamino, di(hydrocarbyl)amino, hydrocarbyleneamino, di(hydrocarbyl)phosphino, hydrocarbylene-phosphino, hydrocarbylsulfido, halo-substituted hydrocarbyl, hydrocarbyloxy-substituted hydrocarbyl, silyl-substituted hydrocarbyl, hydrocarbylsiloxy-substituted hydrocarbyl, hydrocarbylsilylamino-substituted hydrocarbyl, di(hydrocarbyl)amino-substituted hydrocarbyl, hydrocarbyleneamino-substituted hydrocarbyl, di(hydrocarbyl)phosphino-substituted hydrocarbyl, hydrocarbylenephosphino-substituted hydrocarbyl, or hydrocarbylsulfido-substituted hydrocarbyl, said R¹⁰ group having up to 40 atoms not counting hydrogen atoms, and optionally two or more of the foregoing adjacent R¹⁰ groups may together form a divalent derivative thereby forming a saturated or unsaturated fused ring;
X^{a} is a divalent moiety lacking in delocalized t-electrons, or such a moiety comprising one σ-bond and a neutral two electron pair able to form a coordinate-covalent bond to M, said X^{a} comprising boron, or a member of Group 14 of the Periodic Table of the Elements, and also comprising nitrogen, phosphorus, sulfur or oxygen;
X is a monovalent anionic ligand group having up to 60 atoms exclusive of the class of ligands that are cyclic ligand groups bound to M through delocalized π-electrons or two X groups together are a divalent anionic ligand group;
Z independently at each occurrence is a neutral ligating compound having up to 20 atoms;
x is 0, 1, 2, or 3;
and z is 0 or 1.

Illustratively, T is ═N(CH₃), X is halo or hydrocarbyl, x is 2, X^{a} is dimethylsilane, z is 0, and R¹⁰ at each occurrence is hydrogen, a hydrocarbyl, hydrocarbyloxy, dihydrocarbylamino, hydrocarbyleneamino, dihydrocarbylamino-substituted hydrocarbyl group, or hydrocarbyleneamino-substituted hydrocarbyl group of up to 20 atoms not counting hydrogen, and optionally two R¹⁰ groups may be joined together.

Illustrative metal complexes of the foregoing formula that may be employed in the practice of the present invention further include the following compounds:
(t-butylamido)dimethyl-[6,7]benzo-[4,5:2′,3′](1-methylisoindol)-(3H)-indene-2-yl)silanetitanium (II) 1,4-diphenyl-1,3-butadiene,
(t-butylamido)dimethyl-[6,7]benzo-[4,5:2′,3′](1-methylisoindol)-(3H)-indene-2-yl)silanetitanium (II) 1,3-pentadiene,
(t-butylamido)dimethyl-[6,7]benzo-[4,5:2′,3′](1-methylisoindol)-(3H)-indene-2-yl)silanetitanium (III) 2-(N,N-dimethylamino)benzyl,
(t-butylamido)dimethyl-[6,7]benzo-[4,5:2′,3′](1-methylisoindol)-(3H)-indene-2-yl)silanetitanium (IV) dichloride,
(t-butylamido)dimethyl-[6,7]benzo-[4,5:2′,3′](1-methylisoindol)-(3H)-indene-2-yl)silanetitanium (IV) dimethyl,
(t-butylamido)dimethyl-[6,7]benzo-[4,5:2′,3′](1-methylisoindol)-(3H)-indene-2-yl)silanetitanium (IV) dibenzyl,
(t-butylamido)dimethyl-[6,7]benzo-[4,5:2′,3′](1-methylisoindol)-(3H)-indene-2-yl)silanetitanium (IV) bis(trimethylsilyl),
(cyclohexylamido)dimethyl-[6,7]benzo-[4,5:2′,3′](1-methylisoindol)-(3H)-indene-2-yl)silanetitanium (II) 1,4-diphenyl-1,3-butadiene,
(cyclohexylamido)dimethyl-[6,7]benzo-[4,5:2′,3′](1-methylisoindol)-(3H)-indene-2-yl)silanetitanium (II) 1,3-pentadiene,
(cyclohexylamido)dimethyl-[6,7]benzo-[4,5:2′,3′](1-methylisoindol)-(3H)-indene-2-yl)silanetitanium (III) 2-(N,N-dimethylamino)benzyl,
(cyclohexylamido)dimethyl-[6,7]benzo-[4,5:2′,3′](1-methylisoindol)-(3H)-indene-2-yl)silanetitanium (IV) dichloride,
(cyclohexylamido)dimethyl-[6,7]benzo-[4,5:2′,3′](1-methylisoindol)-(3H)-indene-2-yl)silanetitanium (IV) dimethyl,
(cyclohexylamido)dimethyl-[6,7]benzo-[4,5:2′,3′](1-methylisoindol)-(3H)-indene-2-yl)silanetitanium (IV) dibenzyl,
(cyclohexylamido)dimethyl-[6,7]benzo-[4,5:2′,3′](1-methylisoindol)-(3H)-indene-2-yl)silanetitanium (IV) bis(trimethylsilyl),
(t-butylamido)di(p-methylphenyl)-[6,7]benzo-[4,5:2′,3′](1-methylisoindol)-(3H)-indene-2-yl)silanetitanium (II) 1,4-diphenyl-1,3-butadiene,
(t-butylamido)di(p-methylphenyl)-[6,7]benzo-[4,5:2′,3′](1-methylisoindol)-(3H)-indene-2-yl)silanetitanium (II) 1,3-pentadiene,
(t-butylamido)di(p-methylphenyl)-[6,7]benzo-[4,5:2′,3′](1-methylisoindol)-(3H)-indene-2-yl)silanetitanium (III) 2-(N,N-dimethylamino)benzyl,
(t-butylamido)di(p-methylphenyl)-[6,7]benzo-[4,5:2′,3′](1-methylisoindol)-(3H)-indene-2-yl)silanetitanium (IV) dichloride,
(t-butylamido)di(p-methylphenyl)-[6,7]benzo-[4,5:2′,3′](1-methylisoindol)-(3H)-indene-2-yl)silanetitanium (IV) dimethyl,
(t-butylamido)di(p-methylphenyl)-[6,7]benzo-[4,5:2′,3′](1-methylisoindol)-(3H)-indene-2-yl)silanetitanium (IV) dibenzyl,
(t-butylamido)di(p-methylphenyl)-[6,7]benzo-[4,5:2′,3′](1-methylisoindol)-(3H)-indene-2-yl)silanetitanium (IV) bis(trimethylsilyl),
(cyclohexylamido)di(p-methylphenyl)-[6,7]benzo-[4,5:2′,3′](1-methylisoindol)-(3H)-indene-2-yl)silanetitanium (II) 1,4-diphenyl-1,3-butadiene,
(cyclohexylamido)di(p-methylphenyl)-[6,7]benzo-[4,5:2′,3′](1-methylisoindol)-(3H)-indene-2-yl)silanetitanium (II) 1,3-pentadiene,
(cyclohexylamido)di(p-methylphenyl)-[6,7]benzo-[4,5:2′,3′](1-methylisoindol)-(3H)-indene-2-yl)silanetitanium (III) 2-(N,N-dimethylamino)benzyl,
(cyclohexylamido)di(p-methylphenyl)-[6,7]benzo-[4,5:2′,3′](1-methylisoindol)-(3H)-indene-2-yl)silanetitanium (IV) dichloride,
(cyclohexylamido)di(p-methylphenyl)-[6,7]benzo-[4,5:2′,3′](1-methylisoindol)-(3H)-indene-2-yl)silanetitanium (IV) dimethyl,
(cyclohexylamido)di(p-methylphenyl)-[6,7]benzo-[4,5:2′,3′](1-methylisoindol)-(3H)-indene-2-yl)silanetitanium (IV) dibenzyl; and
(cyclohexylamido)di(p-methylphenyl)-[6,7]benzo-[4,5:2′,3′](1-methylisoindol)-(3H)-indene-2-yl)silanetitanium (IV) bis(trimethylsilyl).

Illustrative Group 4 metal complexes that may be employed in the practice of the present disclosure further include:
(tert-butylamido)(1,1-dimethyl-2,3,4,9,10-η-1,4,5,6,7,8-hexahydronaphthalenyl)dimethylsilanetitaniumdimethyl
(tert-butylamido)(1,1,2,3-tetramethyl-2,3,4,9,10-η-1,4,5,6,7,8-hexahydronaphthalenyl)dimethylsilanetitaniumdimethyl,
(tert-butylamido)(tetramethyl-η⁵-cyclopentadienyl) dimethylsilanetitanium dibenzyl,
(tert-butylamido)(tetramethyl-η⁵-cyclopentadienyl)dimethylsilanetitanium dimethyl,
(tert-butylamido)(tetramethyl-η⁵-cyclopentadienyl)-1,2-ethanediyltitanium dimethyl,
(tert-butylamido)(tetramethyl-η⁵-indenyl)dimethylsilanetitanium dimethyl,
(tert-butylamido)(tetramethyl-η⁵-cyclopentadienyl)dimethylsilane titanium (III) 2-(dimethylamino)benzyl;
(tert-butylamido)(tetramethyl-η⁵-cyclopentadienyl)dimethylsilanetitanium (III) allyl,
(tert-butylamido)(tetramethyl-η⁵-cyclopentadienyl)dimethylsilanetitanium (III) 2,4-dimethylpentadienyl,
(tert-butylamido)(tetramethyl-η⁵-cyclopentadienyl)dimethylsilanetitanium (II) 1,4-diphenyl-1,3-butadiene,
(tert-butylamido)(tetramethyl-η⁵-cyclopentadienyl)dimethylsilanetitanium (I) 1,3-pentadiene,
(tert-butylamido)(2-methylindenyl)dimethylsilanetitanium (I) 1,4-diphenyl-1,3-butadiene,
(tert-butylamido)(2-methylindenyl)dimethylsilanetitanium (I) 2,4-hexadiene,
(tert-butylamido)(2-methylindenyl)dimethylsilanetitanium (IV) 2,3-dimethyl-1,3-butadiene,
(tert-butylamido)(2-methylindenyl)dimethylsilanetitanium (IV) isoprene,
(tert-butylamido)(2-methylindenyl)dimethylsilanetitanium (IV) 1,3-butadiene,
(tert-butylamido)(2,3-dimethylindenyl)dimethylsilanetitanium (IV) 2,3-dimethyl-1,3-butadiene,
(tert-butylamido)(2,3-dimethylindenyl)dimethylsilanetitanium (IV) isoprene,
(tert-butylamido)(2,3-dimethylindenyl)dimethylsilanetitanium (IV) dimethyl,
(tert-butylamido)(2,3-dimethylindenyl)dimethylsilanetitanium (IV) dibenzyl,
(tert-butylamido)(2,3-dimethylindenyl)dimethylsilanetitanium (IV) 1,3-butadiene,
(tert-butylamido)(2,3-dimethylindenyl)dimethylsilanetitanium (I) 1,3-pentadiene,
(tert-butylamido)(2,3-dimethylindenyl)dimethylsilanetitanium (II) 1,4-diphenyl-1,3-butadiene,
(tert-butylamido)(2-methylindenyl)dimethylsilanetitanium (II) 1,3-pentadiene,
(tert-butylamido)(2-methylindenyl)dimethylsilanetitanium (IV) dimethyl,
(tert-butylamido)(2-methylindenyl)dimethylsilanetitanium (IV) dibenzyl,
(tert-butylamido)(2-methyl-4-phenylindenyl)dimethylsilanetitanium (II) 1,4-diphenyl-1,3-butadiene,
(tert-butylamido)(2-methyl-4-phenylindenyl)dimethylsilanetitanium (II) 1,3-pentadiene,
(tert-butylamido)(2-methyl-4-phenylindenyl)dimethylsilanetitanium (II) 2,4-hexadiene,
(tert-butylamido)(tetramethyl-η⁵-cyclopentadienyl)dimethyl-silanetitanium (IV) 1,3-butadiene,
(tert-butylamido)(tetramethyl-η⁵-cyclopentadienyl)dimethylsilanetitanium (IV) 2,3-dimethyl-1,3-butadiene,
(tert-butylamido)(tetramethyl-η⁵-cyclopentadienyl)dimethylsilanetitanium (IV) isoprene,
(tert-butylamido)(tetramethyl-η⁵-cyclopentadienyl)dimethyl-silanetitanium (II) 1,4-dibenzyl-1,3-butadiene,
(tert-butylamido)(tetramethyl-η⁵-cyclopentadienyl)dimethylsilanetitanium (II) 2,4-hexadiene,
(tert-butylamido)(tetramethyl-η⁵-cyclopentadienyl)dimethyl-silanetitanium (II) 3-methyl-1,3-pentadiene,
(tert-butylamido)(2,4-dimethylpentadien-3-yl)dimethylsilanetitaniumdimethyl,
(tert-butylamido)(6,6-dimethylcyclohexadienyl)dimethylsilanetitaniumdimethyl,
(tert-butylamido)(1,1-dimethyl-2,3,4,9,10-η-1,4,5,6,7,8-hexahydronaphthalen-4-yl)dimethylsilanetitaniumdimethyl,
(tert-butylamido)(1,1,2,3-tetramethyl-2,3,4,9,10-η-1,4,5,6,7,8-hexahydronaphthalen-4-yl)dimethylsilanetitaniumdimethyl,
(tert-butylamido)(tetramethyl-η⁵-cyclopentadienyl methylphenylsilanetitanium (IV) dimethyl,
(tert-butylamido)(tetramethyl-η⁵-cyclopentadienyl methylphenylsilanetitanium (I) 1,4-diphenyl-1,3-butadiene,
1-(tert-butylamido)-2-(tetramethyl-η⁵-cyclopentadienyl)ethanediyltitanium (IV) dimethyl, and
1-(tert-butylamido)-2-(tetramethyl-η⁵-cyclopentadienyl)ethanediyl-titanium (I) 1,4-diphenyl-1,3-butadiene.

Other delocalized, π-bonded complexes, especially those containing other Group 4 metals, will, of course, be apparent to those skilled in the art, and are disclosed among other places in: WO 03/78480, WO 03/78483, WO 02/92610, WO 02/02577, US 2003/0004286 and U.S. Pat. Nos. 6,515,155, 6,555,634, 6,150,297, 6,034,022, 6,268,444, 6,015,868, 5,866,704, and 5,470,993.

Additional examples of metal complexes that are usefully employed as catalysts are complexes of polyvalent Lewis bases, such as compounds corresponding to the formula:

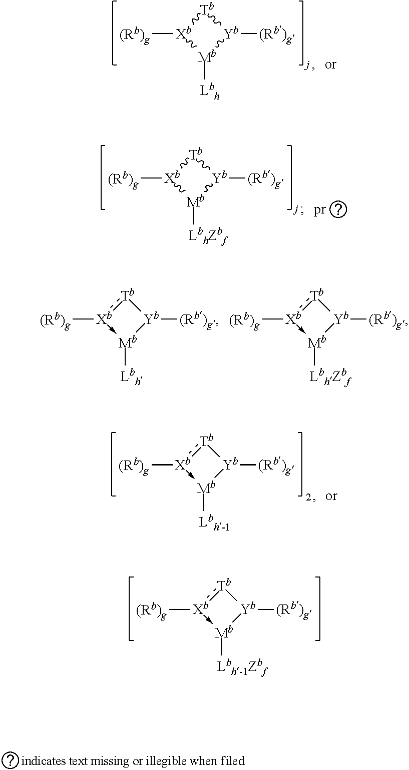

wherein T^{b} is a bridging group, preferably containing 2 or more atoms other than hydrogen, X^{b} and Y^{b} are each independently selected from the group consisting of nitrogen, sulfur, oxygen and phosphorus; more preferably both X^{b} and Y^{b} are nitrogen,
R^{b} and R^{b}′ independently each occurrence are hydrogen or C₁₋₅₀ hydrocarbyl groups optionally containing one or more heteroatoms or inertly substituted derivative thereof. Non-limiting examples of suitable R^{b} and R^{b}′ groups include alkyl, alkenyl, aryl, aralkyl, (poly)alkylaryl and cycloalkyl groups, as well as nitrogen, phosphorus, oxygen and halogen substituted derivatives thereof. Specific examples of suitable Rb and Rb′ groups include methyl, ethyl, isopropyl, octyl, phenyl, 2,6-dimethylphenyl, 2,6-di(isopropyl)phenyl, 2,4,6-trimethylphenyl, pentafluorophenyl, 3,5-trifluoromethylphenyl, and benzyl;
g and g′ are each independently 0 or 1;
M^{b} is a metallic element selected from Groups 3 to 15, or the Lanthanide series of the Periodic Table of the Elements. Preferably, M^{b} is a Group 3-13 metal, more preferably M^{b} is a Group 4-10 metal;
L^{b} is a monovalent, divalent, or trivalent anionic ligand containing from 1 to 50 atoms, not counting hydrogen. Examples of suitable L^{b} groups include halide; hydride; hydrocarbyl, hydrocarbyloxy; di(hydrocarbyl)amido, hydrocarbyleneamido, di(hydrocarbyl)phosphido; hydrocarbylsulfido; hydrocarbyloxy, tri(hydrocarbylsilyl)alkyl; and carboxylates. More preferred L^{b} groups are C1-20 alkyl, C₇₋₂₀ aralkyl, and chloride;
h and h′ are each independently an integer from 1 to 6, preferably from 1 to 4, more preferably from 1 to 3, and j is 1 or 2, with the value h×j selected to provide charge balance;
Z^{b} is a neutral ligand group coordinated to M^{b}, and containing up to 50 atoms not counting hydrogen. Preferred Z^{b} groups include aliphatic and aromatic amines, phosphines, and ethers, alkenes, alkadienes, and inertly substituted derivatives thereof. Suitable inert substituents include halogen, alkoxy, aryloxy, alkoxycarbonyl, aryloxycarbonyl, di(hydrocarbyl)amine, tri(hydrocarbyl)silyl, and nitrile groups. Preferred Z^{b} groups include triphenylphosphine, tetrahydrofuran, pyridine, and 1,4-diphenylbutadiene;
f is an integer from 1 to 3;
two or three of T^{b}, R^{b} and R^{b}′ may be joined together to form a single or multiple ring structure;
h is an integer from 1 to 6, preferably from 1 to 4, more preferably from 1 to 3; [symbol]
indicates any form of electronic interaction, especially coordinate or covalent bonds, including multiple bonds, arrows signify coordinate bonds, and dotted lines indicate optional double bonds.

In one embodiment, it is preferred that R^{b} have relatively low steric hindrance with respect to X^{b}. In this embodiment, most preferred R^{b} groups are straight chain alkyl groups, straight chain alkenyl groups, branched chain alkyl groups wherein the closest branching point is at least 3 atoms removed from X^{b}, and halo, dihydrocarbylamino, alkoxy or trihydrocarbylsilyl substituted derivatives thereof. Highly preferred R^{b} groups in this embodiment are C1-8 straight chain alkyl groups.

At the same time, in this embodiment R^{b}′ preferably has relatively high steric hindrance with respect to Y^{b}. Non-limiting examples of suitable R^{b}′ groups for this embodiment include alkyl or alkenyl groups containing one or more secondary or tertiary carbon centers, cycloalkyl, aryl, alkaryl, aliphatic or aromatic heterocyclic groups, organic or inorganic oligomeric, polymeric or cyclic groups, and halo, dihydrocarbylamino, alkoxy or trihydrocarbylsilyl substituted derivatives thereof. Preferred R^{b}′ groups in this embodiment contain from 3 to 40, more preferably from 3 to 30, and most preferably from 4 to 20 atoms not counting hydrogen and are branched or cyclic. Examples of preferred T^{b} groups are structures corresponding to the following formulas:

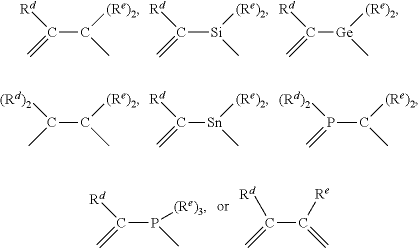

wherein
Each R^{d} is C₁₋₁₀ hydrocarbyl group, preferably methyl, ethyl, n-propyl, i-propyl, t-butyl, phenyl, 2,6-dimethylphenyl, benzyl, or tolyl. Each R^{e} is C₁₋₁₀ hydrocarbyl, preferably methyl, ethyl, n-propyl, i-propyl, t-butyl, phenyl, 2,6-dimethylphenyl, benzyl, or tolyl. In addition, two or more R^{d} or R^{e} groups, or mixtures of Rd and Re groups may together form a polyvalent derivative of a hydrocarbyl group, such as, 1,4-butylene, 1,5-pentylene, or a multicyclic, fused ring, polyvalent hydrocarbyl- or heterohydrocarbyl-group, such as naphthalene-1,8-diyl.

Suitable examples of the foregoing polyvalent Lewis base complexes include:

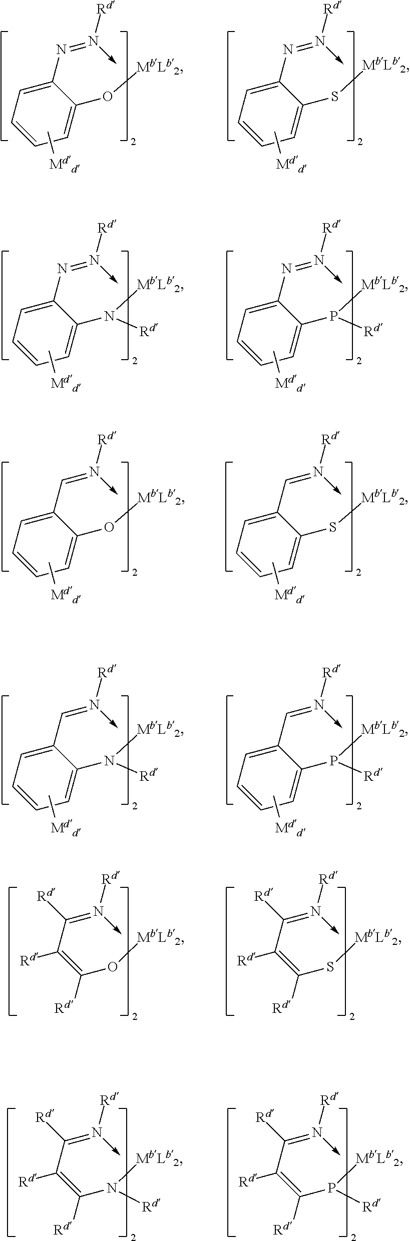

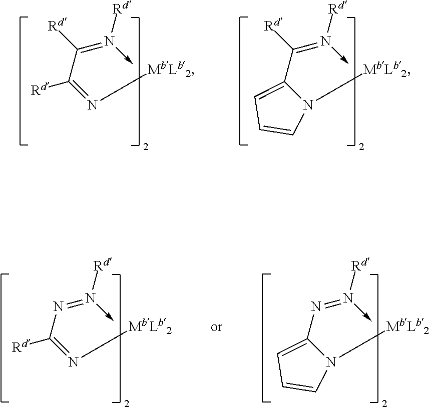

wherein R^{d′} at each occurrence is independently selected from the group consisting of hydrogen and C1-50 hydrocarbyl groups optionally containing one or more heteroatoms, or inertly substituted derivative thereof, or further optionally, two adjacent R^{d′} groups may together form a divalent bridging group;
d′ is 4;
M^{b′} is a Group 4 metal, preferably titanium or hafnium, or a Group 10 metal, preferably Ni or Pd;
L^{b′} is a monovalent ligand of up to 50 atoms not counting hydrogen, preferably halide or hydrocarbyl, or two L^{b′} groups together are a divalent or neutral ligand group, preferably a C₂₋₅₀ hydrocarbylene, hydrocarbadiyl or diene group.

The polyvalent Lewis base complexes for use in the present invention especially include Group 4 metal derivatives, especially hafnium derivatives of hydrocarbylamine substituted heteroaryl compounds corresponding to the formula:

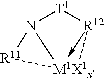

wherein:
R¹¹ is selected from alkyl, cycloalkyl, heteroalkyl, cycloheteroalkyl, aryl, and inertly substituted derivatives thereof containing from 1 to 30 atoms not counting hydrogen or a divalent derivative thereof;
T¹ is a divalent bridging group of from 1 to 41 atoms other than hydrogen, preferably 1 to 20 atoms other than hydrogen, and most preferably a mono- or di-C1-20 hydrocarbyl substituted methylene or silane group; and
R¹² is a C₅₋₂₀ heteroaryl group containing Lewis base functionality, especially a pyridin-2-yl- or substituted pyridin-2-yl group or a divalent derivative thereof;
M¹ is a Group 4 metal, preferably hafnium;
X¹ is an anionic, neutral or dianionic ligand group;
x′ is a number from 0 to 5 indicating the number of such X¹ groups; and bonds, optional bonds and electron donative interactions are represented by lines, dotted lines and arrows respectively.

Suitable complexes are those wherein ligand formation results from hydrogen elimination from the amine group and optionally from the loss of one or more additional groups, especially from R¹². In addition, electron donation from the Lewis base functionality, preferably an electron pair, provides additional stability to the metal center. Suitable metal complexes correspond to the formula:

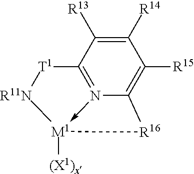

wherein M¹, X¹, x′, R¹¹ and T¹ are as previously defined,
R¹³, R¹⁴, R¹⁵ and R¹⁶ are hydrogen, halo, or an alkyl, cycloalkyl, heteroalkyl, heterocycloalkyl, aryl, or silyl group of up to 20 atoms not counting hydrogen, or adjacent R¹³, R¹⁴, R¹⁵ or R¹⁶ groups may be joined together thereby forming fused ring derivatives, and bonds, optional bonds and electron pair donative interactions are represented by lines, dotted lines and arrows respectively. Suitable examples of the foregoing metal complexes correspond to the formula:

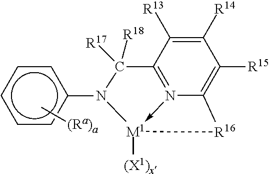

wherein
M¹, X¹, and x′ are as previously defined,
R¹³, R¹⁴, R¹⁵ and R¹⁶ are as previously defined, preferably R¹³, R¹⁴, and R¹⁵ are hydrogen, or C₁₋₄ alkyl, and R¹⁶ is C₆₋₂o aryl, most preferably naphthalenyl;
R^{a} independently at each occurrence is C₁₋₄ alkyl, and a is 1-5, most preferably Rain two ortho-positions to the nitrogen is isopropyl or t-butyl;
R¹⁷ and R¹⁸ independently at each occurrence are hydrogen, halogen, or a C₁₋₂₀ alkyl or aryl group, most preferably one of R¹⁷ and R¹⁸ is hydrogen and the other is a C6-20 aryl group, especially 2-isopropyl, phenyl or a fused polycyclic aryl group, most preferably an anthracenyl group, and bonds, optional bonds and electron pair donative interactions are represented by lines, dotted lines and arrows respectively.

Exemplary metal complexes for use herein as catalysts correspond to the formula:

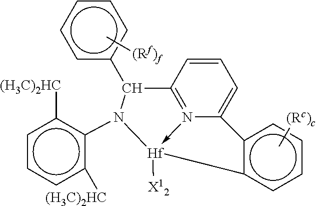

wherein X¹ at each occurrence is halide, N,N-dimethylamido, or C₁₋₄ alkyl, and preferably at each occurrence X¹ is methyl;
R^{f} independently at each occurrence is hydrogen, halogen, C1-20 alkyl, or C6-20 aryl, or two adjacent R^{f} groups are joined together thereby forming a ring, and f is 1-5; and
R^{c} independently at each occurrence is hydrogen, halogen, C₁₋₂₀ alkyl, or C₆₋₂₀ aryl, or two adjacent R^{c} groups are joined together thereby forming a ring, and c is 1-5.

Suitable examples of metal complexes for use as catalysts according to the present invention are complexes of the following formulas:

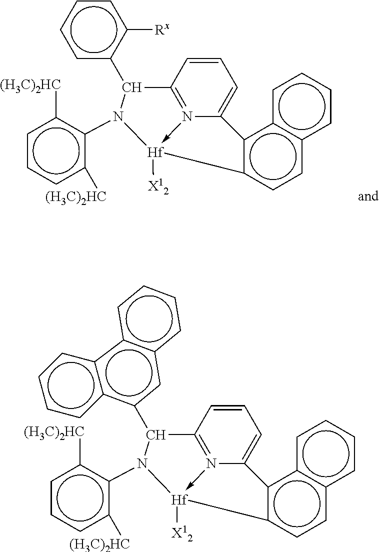

wherein R^{x} is C1-4 alkyl or cycloalkyl, preferably methyl, isopropyl, t-butyl or cyclohexyl; and
X¹ at each occurrence is halide, N,N-dimethylamido, or C1-4 alkyl, preferably methyl.

Examples of metal complexes usefully employed as catalysts according to the present invention include:
[N-(2,6-di(1-methylethyl)phenyl)amido)(o-tolyl)(α-naphthalen-2-diyl(6-pyridin-2-diyl)methane)]hafnium dimethyl;
[N-(2,6-di(1-methylethyl)phenyl)amido)(o-tolyl)(α-naphthalen-2-diyl(6-pyridin-2-diyl)methane)]hafnium di(N,N-dimethylamido);
[N-(2,6-di(1-methylethyl)phenyl)amido)(o-tolyl)(α-naphthalen-2-diyl(6-pyridin-2-diyl)methane)]hafnium dichloride;
[N-(2,6-di(1-methylethyl)phenyl)amido)(2-isopropylphenyl)(α-naphthalen-2-diyl(6-pyridin-2-diyl)methane)]hafnium dimethyl;
[N-(2,6-di(1-methylethyl)phenyl)amido)(2-isopropylphenyl)(α-naphthalen-2-diyl(6-pyridin-2-diyl)methane)]hafnium di(N,N-dimethylamido);
[N-(2,6-di(1-methylethyl)phenyl)amido)(2-isopropylphenyl)(α-naphthalen-2-diyl(6-pyridin-2-diyl)methane)]hafnium dichloride;
[N-(2,6-di(1-methylethyl)phenyl)amido)(phenanthren-5-yl)(α-naphthalen-2-diyl(6-pyridin-2-diyl)methane)]hafnium dimethyl;
[N-(2,6-di(1-methylethyl)phenyl)amido)(phenanthren-5-yl)(α-naphthalen-2-diyl(6-pyridin-2-diyl)methane)]hafnium di(N,N-dimethylamido); and
[N-(2,6-di(1-methylethyl)phenyl)amido)(phenanthren-5-yl)(α-naphthalen-2-diyl(6-pyridin-2-diyl)methane)]hafnium dichloride.

Under the reaction conditions used to prepare the metal complexes used in the present disclosure, the hydrogen of the 2-position of the α-naphthalene group substituted at the 6-position of the pyridin-2-yl group is subject to elimination, thereby uniquely forming metal complexes wherein the metal is covalently bonded to both the resulting amide group and to the 2-position of the α-naphthalenyl group, as well as stabilized by coordination to the pyridinyl nitrogen atom through the electron pair of the nitrogen atom.

Additional suitable metal complexes of polyvalent Lewis bases for use herein include compounds corresponding to the formula:

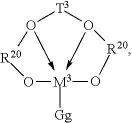

wherein:
R²⁰ is an aromatic or inertly substituted aromatic group containing from 5 to 20 atoms not counting hydrogen, or a polyvalent derivative thereof;
T³ is a hydrocarbylene or hydrocarbyl silane group having from 1 to 20 atoms not counting hydrogen, or an inertly substituted derivative thereof;
M³ is a Group 4 metal, preferably zirconium or hafnium;
G is an anionic, neutral or dianionic ligand group; preferably a halide, hydrocarbyl, silane, trihydrocarbylsilylhydrocarbyl, trihydrocarbylsilyl, or dihydrocarbylamide group having up to 20 atoms not counting hydrogen;
g is a number from 1 to 5 indicating the number of such G groups; and bonds and electron donative interactions are represented by lines and arrows respectively.

Illustratively, such complexes correspond to the formula:

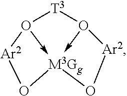

wherein:
T³ is a divalent bridging group of from 2 to 20 atoms not counting hydrogen, preferably a substituted or unsubstituted, C3-6 alkylene group;
and Ar² independently at each occurrence is an arylene or an alkyl- or aryl-substituted arylene group of from 6 to 20 atoms not counting hydrogen;
M³ is a Group 4 metal, preferably hafnium or zirconium;
G independently at each occurrence is an anionic, neutral or dianionic ligand group;
g is a number from 1 to 5 indicating the number of such X groups; and electron donative interactions are represented by arrows.

Suitable examples of metal complexes of foregoing formula include the following compounds

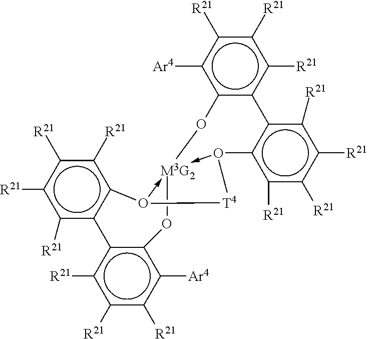

where M³ is Hf or Zr;
Ar⁴ is C₆₋₂₀ aryl or inertly substituted derivatives thereof, especially 3,5-di(isopropyl)phenyl, 3,5-di(isobutyl)phenyl, dibenzo-1H-pyrrole-1-yl, or anthracen-5-yl, and
T⁴ independently at each occurrence comprises a C₃₋₆ alkylene group, a C₃₋₆ cycloalkylene group, or an inertly substituted derivative thereof;
R²¹ independently at each occurrence is hydrogen, halo, hydrocarbyl, trihydrocarbylsilyl, or trihydrocarbylsilylhydrocarbyl of up to 50 atoms not counting hydrogen; and
G, independently at each occurrence is halo or a hydrocarbyl or trihydrocarbylsilyl group of up to 20 atoms not counting hydrogen, or 2 G groups together are a divalent derivative of the foregoing hydrocarbyl or trihydrocarbylsilyl groups.

Suitable compounds are compounds of the formulas:

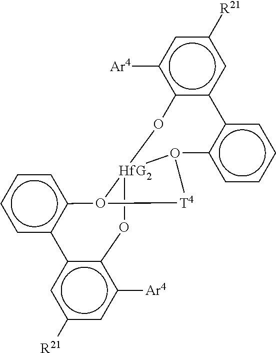

wherein Ar⁴ is 3,5-di(isopropyl)phenyl, 3,5-di(isobutyl)phenyl, dibenzo-1H-pyrrole-1-yl, or anthracen-5-yl,
R²¹ is hydrogen, halo, or C₁₋₄ alkyl, especially methyl
T⁴ is propan-1,3-diyl or butan-1,4-diyl, and
G is chloro, methyl or benzyl.

An exemplary metal complex of the foregoing formula is:

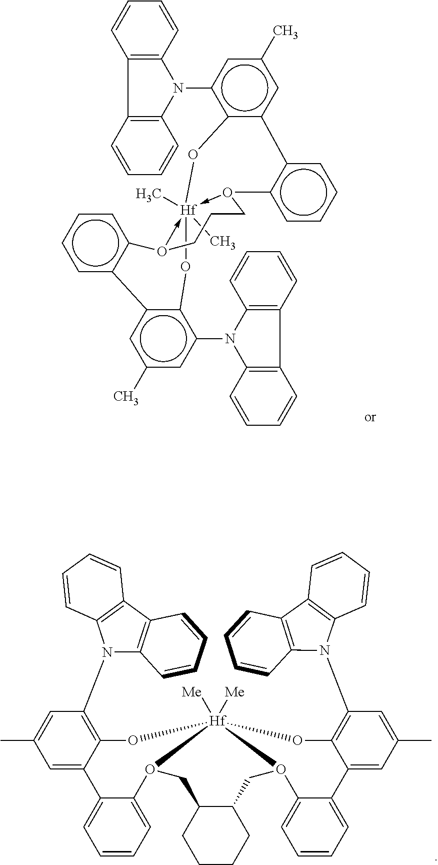

Suitable metal complexes for use according to the present disclosure further include compounds corresponding to the formula:

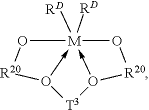

where:
M is zirconium or hafnium;
R²⁰ independently at each occurrence is a divalent aromatic or inertly substituted aromatic group containing from 5 to 20 atoms not counting hydrogen;
T³ is a divalent hydrocarbon or silane group having from 3 to 20 atoms not counting hydrogen, or an inertly substituted derivative thereof; and
R^{D} independently at each occurrence is a monovalent ligand group of from 1 to 20 atoms, not counting hydrogen, or two R^{D} groups together are a divalent ligand group of from 1 to 20 atoms, not counting hydrogen.

Such complexes may correspond to the formula:

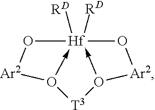

wherein:
Ar² independently at each occurrence is an arylene or an alkyl-, aryl-, alkoxy- or amino-substituted arylene group of from 6 to 20 atoms not counting hydrogen or any atoms of any substituent;
T³ is a divalent hydrocarbon bridging group of from 3 to 20 atoms not counting hydrogen, preferably a divalent substituted or unsubstituted C₃₋₆ aliphatic, cycloaliphatic, or bis(alkylene)-substituted cycloaliphatic group having at least 3 carbon atoms separating oxygen atoms; and
R^{D} independently at each occurrence is a monovalent ligand group of from 1 to 20 atoms, not counting hydrogen, or two R^{D} groups together are a divalent ligand group of from 1 to 40 atoms, not counting hydrogen.

Further examples of metal complexes suitable for use herein include compounds of the formula:

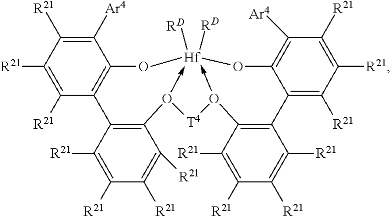

where
Ar⁴ independently at each occurrence is C₆₋₂₀ aryl or inertly substituted derivatives thereof, especially 3,5-di(isopropyl)phenyl, 3,5-di(isobutyl)phenyl, dibenzo-1H-pyrrole-1-yl, naphthyl, anthracen-5-yl, 1,2,3,4,6,7,8,9-octahydroanthracen-5-yl;
T⁴ independently at each occurrence is a propylene-1,3-diyl group, a bis(alkylene)cyclohexan-1,2-diyl group, or an inertly substituted derivative thereof substituted with from 1 to 5 alkyl, aryl or aralkyl substituents having up to 20 carbons each;
R²¹ independently at each occurrence is hydrogen, halo, hydrocarbyl, trihydrocarbylsilyl, trihydrocarbylsilylhydrocarbyl, alkoxy or amino of up to 50 atoms not counting hydrogen; and
R^{D}, independently at each occurrence is halo or a hydrocarbyl or trihydrocarbylsilyl group of up to 20 atoms not counting hydrogen, or 2 R^{D} groups together are a divalent hydrocarbylene, hydrocarbadiyl or trihydrocarbylsilyl group of up to 40 atoms not counting hydrogen.

Exemplary metal complexes are compounds of the formula:

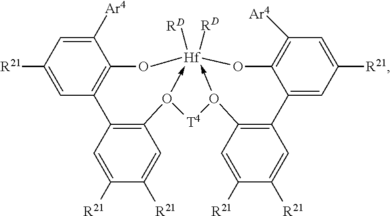

where, Ar⁴, independently at each occurrence, is 3,5-di(isopropyl)phenyl, 3,5-di(isobutyl)phenyl, dibenzo-1H-pyrrole-1-yl, or anthracen-5-yl,
R²¹ independently at each occurrence is hydrogen, halo, hydrocarbyl, trihydrocarbylsilyl, trihydrocarbylsilylhydrocarbyl, alkoxy or amino of up to 50 atoms not counting hydrogen;
T⁴ is propan-1,3-diyl or bis(methylene)cyclohexan-1,2-diyl; and
R^{D}, independently at each occurrence is halo or a hydrocarbyl or trihydrocarbylsilyl group of up to 20 atoms not counting hydrogen, or 2 R^{D} groups together are a hydrocarbylene, hydrocarbadiyl or hydrocarbylsilanediyl group of up to 40 atoms not counting hydrogen.

Suitable metal complexes according to the present disclosure correspond to the formulas:

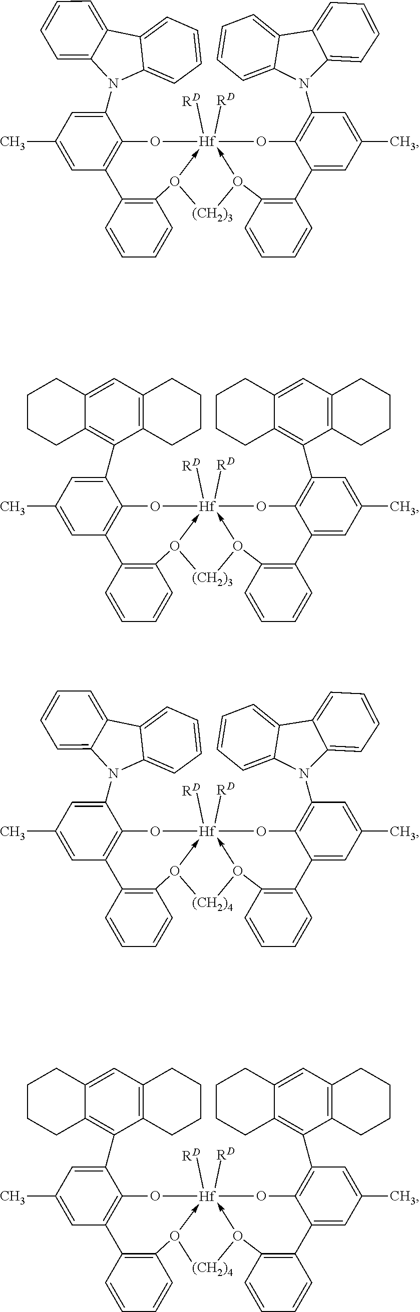

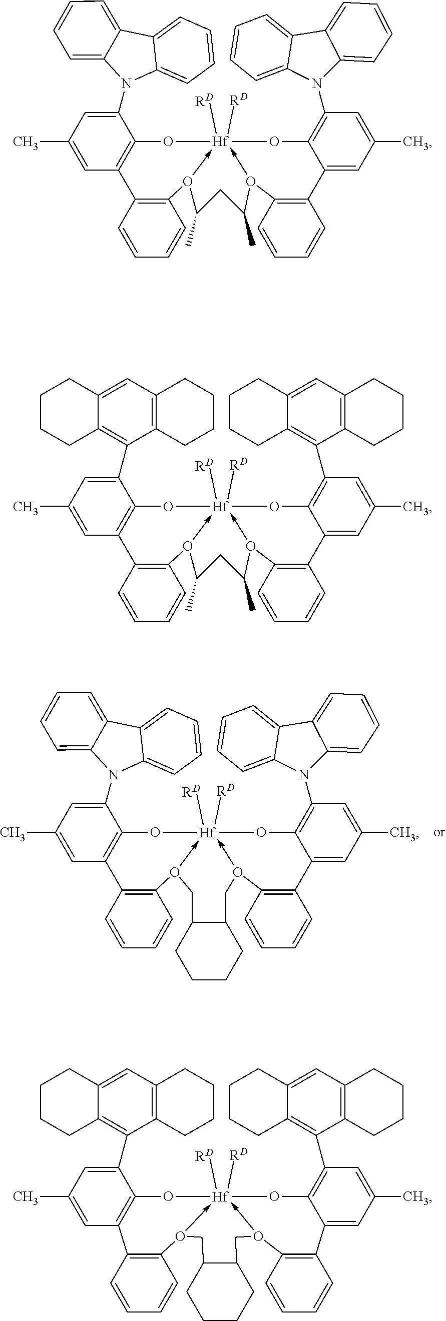

wherein, R^{D} independently at each occurrence is chloro, methyl or benzyl.

Specific examples of suitable metal complexes are the following compounds:
A) bis((2-oxoyl-3-(1,2,3,4,6,7,8,9-octahydroanthracen-5-yl)-5-(methyl)phenyl)-2-phenoxy)-1,3-propanediylhafnium (IV) dimethyl,
bis((2-oxoyl-3-(1,2,3,4,6,7,8,9-octahydroanthracen-5-yl)-5-(methyl)phenyl)-2-phenoxy)-1,3-propanediylhafnium (IV) dichloride,
bis((2-oxoyl-3-(1,2,3,4,6,7,8,9-octahydroanthracen-5-yl)-5-(methyl)phenyl)-2-phenoxy)-1,3-propanediylhafnium (IV) dibenzyl,
bis((2-oxoyl-3-(dibenzo-1H-pyrrole-1-yl)-5-(methyl)phenyl)-2-phenoxy)-1,3-propanediylhafnium (IV) dimethyl,
bis((2-oxoyl-3-(dibenzo-1H-pyrrole-1-yl)-5-(methyl)phenyl)-2-phenoxy)-1,3-propanediylhafnium (IV) dichloride,
bis((2-oxoyl-3-(dibenzo-1H-pyrrole-1-yl)-5-(methyl)phenyl)-2-phenoxy)-1,3-propanediylhafnium (IV) dibenzyl,
B) bis((2-oxoyl-3-(1,2,3,4,6,7,8,9-octahydroanthracen-5-yl)-5-(methyl)phenyl)-2-phenoxymethyl)-1,4-butanediylhafnium (IV) dimethyl,
bis((2-oxoyl-3-(1,2,3,4,6,7,8,9-octahydroanthracen-5-yl)-5-(methyl)phenyl)-2-phenoxymethyl)-1,4-butanediylhafnium (IV) dichloride,
bis((2-oxoyl-3-(1,2,3,4,6,7,8,9-octahydroanthracen-5-yl)-5-(methyl)phenyl)-2-phenoxymethyl)-1,4-butanediylhafnium (IV) dibenzyl,
bis((2-oxoyl-3-(dibenzo-1H-pyrrole-1-yl)-5-(methyl)phenyl)-2-phenoxymethyl)-1,4-butanediylhafnium (IV) dimethyl,
bis((2-oxoyl-3-(dibenzo-1H-pyrrole-1-yl)-5-(methyl)phenyl)-2-phenoxymethyl)-1,4-butanediylhafnium (IV) dichloride,
bis((2-oxoyl-3-(dibenzo-1H-pyrrole-1-yl)-5-(methyl)phenyl)-2-phenoxymethyl)-1,4-butanediylhafnium (IV) dibenzyl,
C) bis((2-oxoyl-3-(1,2,3,4,6,7,8,9-octahydroanthracen-5-yl)-5-(methyl)phenyl)-2-phenoxy)-2,4-pentanediylhafnium (IV) dimethyl,
bis((2-oxoyl-3-(1,2,3,4,6,7,8,9-octahydroanthracen-5-yl)-5-(methyl)phenyl)-2-phenoxy)-2,4-pentanediylhafnium (IV) dichloride,
bis((2-oxoyl-3-(1,2,3,4,6,7,8,9-octahydroanthracen-5-yl)-5-(methyl)phenyl)-2-phenoxy)-2,4-pentanediylhafnium (IV) dibenzyl,
bis((2-oxoyl-3-(dibenzo-1H-pyrrole-1-yl)-5-(methyl)phenyl)-2-phenoxy)-2,4-pentanediylhafnium (IV) dimethyl,
bis((2-oxoyl-3-(dibenzo-1H-pyrrole-1-yl)-5-(methyl)phenyl)-2-phenoxy)-2,4-pentanediylhafnium (IV) dichloride,
bis((2-oxoyl-3-(dibenzo-1H-pyrrole-1-yl)-5-(methyl)phenyl)-2-phenoxy)-2,4-pentanediylhafnium (IV) dibenzyl,
D) bis((2-oxoyl-3-(1,2,3,4,6,7,8,9-octahydroanthracen-5-yl)-5-(methyl)phenyl)-2-phenoxymethyl)-methylenetrans-1,2-cyclohexanediylhafnium (IV) dimethyl,
bis((2-oxoyl-3-(1,2,3,4,6,7,8,9-octahydroanthracen-5-yl)-5-(methyl)phenyl)-2-phenoxymethyl)-methylenetrans-1,2-cyclohexanediylhafnium (IV) dichloride,
bis((2-oxoyl-3-(1,2,3,4,6,7,8,9-octahydroanthracen-5-yl)-5-(methyl)phenyl)-2-phenoxymethyl)-methylenetrans-1,2-cyclohexanediylhafnium (IV) dibenzyl,
bis((2-oxoyl-3-(dibenzo-1H-pyrrole-1-yl)-5-(methyl)phenyl)-2-phenoxymethyl)-methylenetrans-1,2-cyclohexanediylhafnium (IV) dimethyl,
bis((2-oxoyl-3-(dibenzo-1H-pyrrole-1-yl)-5-(methyl)phenyl)-2-phenoxymethyl)-methylenetrans-1,2-cyclohexanediylhafnium (IV) dichloride, and
bis((2-oxoyl-3-(dibenzo-1H-pyrrole-1-yl)-5-(methyl)phenyl)-2-phenoxymethyl)-methylenetrans-1,2-cyclohexanediylhafnium (IV) dibenzyl.

The foregoing metal complexes may be conveniently prepared by standard metallation and ligand exchange procedures involving a source of the transition metal and a neutral polyfunctional ligand source. The techniques employed are the same as or analogous to those disclosed in U.S. Pat. No. 6,827,976 and US2004/0010103, and elsewhere.

The metal complex is activated to form the active catalyst composition by combination with the cocatalyst. The activation may occur prior to addition of the catalyst composition to the reactor with or without the presence of other components of the reaction mixture, or in situ through separate addition of the metal complex and activating cocatalyst to the reactor.

The foregoing polyvalent Lewis base complexes are conveniently prepared by standard metallation and ligand exchange procedures involving a source of the Group 4 metal and the neutral polyfunctional ligand source. In addition, the complexes may also be prepared by means of an amide elimination and hydrocarbylation process starting from the corresponding Group 4 metal tetraamide and a hydrocarbylating agent, such as trimethylaluminum. Other techniques may be used as well. These complexes are known from the disclosures of, among others, U.S. Pat. Nos. 6,320,005, 6,103,657, WO 02/38628, WO 03/40195, and U.S. Ser. No. 04/022,0050.

Catalysts having high comonomer incorporation properties are also known to reincorporate in situ prepared long chain olefins resulting incidentally during the polymerization through β-hydride elimination and chain termination of growing polymer, or other process. The concentration of such long chain olefins is particularly enhanced by use of continuous solution polymerization conditions at high conversions, especially ethylene conversions of 95 percent or greater, more preferably at ethylene conversions of 97 percent or greater. Under such conditions a small but detectable quantity of olefin terminated polymer may be reincorporated into a growing polymer chain, resulting in the formation of long chain branches, that is, branches of a carbon length greater than would result from other deliberately added comonomer. Moreover, such chains reflect the presence of other comonomers present in the reaction mixture. That is, the chains may include short chain or long chain branching as well, depending on the comonomer composition of the reaction mixture. Long chain branching of olefin polymers is further described in U.S. Pat. Nos. 5,272,236, 5,278,272, and 5,665,800.

Alternatively, branching, including hyper-branching, may be induced in a particular segment of the present multi-block copolymers by the use of specific catalysts known to result in “chain-walking” in the resulting polymer. For example, certain homogeneous bridged bis indenyl- or partially hydrogenated bis indenyl-zirconium catalysts, disclosed by Kaminski, et al., J. Mol. Catal. A: Chemical, 102 (1995) 59-65; Zambelli, et al., Macromolecules, 1988, 21, 617-622; or Dias, et al., J. Mol. Catal. A: Chemical, 185 (2002) 57-64 may be used to prepare branched copolymers from single monomers, including ethylene. Higher transition metal catalysts, especially nickel and palladium catalysts are also known to lead to hyper-branched polymers (the branches of which are also branched) as disclosed in Brookhart, et al., J. Am. Chem. Soc., 1995, 117, 64145-6415.

Additional complexes suitable for use include Group 4-10 derivatives corresponding to the formula:

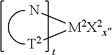

wherein
M² is a metal of Groups 4-10 of the Periodic Table of the elements, preferably Group 4 metals, Ni(I) or Pd(II), most preferably zirconium;
T² is a nitrogen, oxygen or phosphorus containing group;
X² is halo, hydrocarbyl, or hydrocarbyloxy;
t is one or two;
x″ is a number selected to provide charge balance;
and T² and N are linked by a bridging ligand.
Such catalysts have been previously disclosed in J. Am. Chem. Soc., 118, 267-268 (1996), J. Am. Chem. Soc., 117, 6414-6415 (1995), and Organometallics, 16, 1514-1516, (1997), among other disclosures.

Suitable examples of the foregoing metal complexes for use as catalysts are aromatic diimine or aromatic dioxyimine complexes of Group 4 metals, especially zirconium, corresponding to the formula:

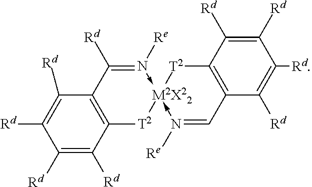

wherein;
M², X² and T² are as previously defined;
R^{d} independently in each occurrence is hydrogen, halogen, or Re; and
R^{e} independently in each occurrence is C1-20 hydrocarbyl or a heteroatom-, especially a F, N, S or P-substituted derivative thereof, more preferably C1-20 hydrocarbyl or a F or N substituted derivative thereof, most preferably alkyl, dialkylaminoalkyl, pyrrolyl, piperidenyl, perfluorophenyl, cycloalkyl, (poly)alkylaryl, or aralkyl.

Suitable examples of the foregoing metal complexes for use as catalysts are aromatic dioxyimine complexes of zirconium, corresponding to the formula:

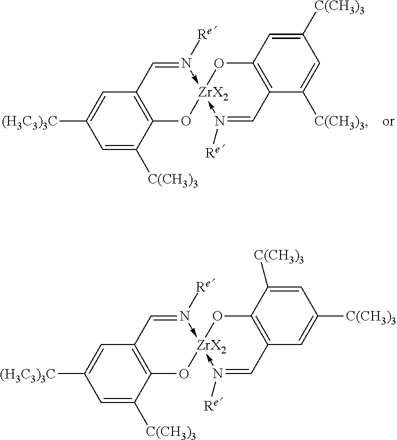

wherein;
X² is as previously defined, preferably C1-10 hydrocarbyl, most preferably methyl or benzyl; and
R^{e′} is methyl, isopropyl, t-butyl, cyclopentyl, cyclohexyl, 2-methylcyclohexyl, 2,4-dimethylcyclohexyl, 2-pyrrolyl, N-methyl-2-pyrrolyl, 2-piperidenyl, N-methyl-2-piperidenyl, benzyl, o-tolyl, 2,6-dimethylphenyl, perfluorophenyl, 2,6-di(isopropyl)phenyl, or 2,4,6-trimethylphenyl.

The foregoing complexes for use as also include certain phosphinimine complexes are disclosed in EP-A-890581. These complexes correspond to the formula: [(R^{f})₃—P═N]_{f}M(K²)(R^{f})_{3-f}, wherein: R^{f} is a monovalent ligand or two R^{f} groups together are a divalent ligand, preferably R^{f} is hydrogen or C1-4 alkyl;

M is a Group 4 metal,
K² is a group containing delocalized π-electrons through which K² is bound to M, said
K² group containing up to 50 atoms not counting hydrogen atoms, and f is 1 or 2.

Further suitable procatalysts include a metal-ligand complex of Formula (i):

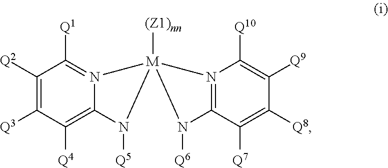

wherein M is titanium, zirconium, or hafnium;

wherein each Z1 is independently a monodentate or polydentate ligand that is neutral, monoanionic, or dianionic, wherein nn is an integer, and wherein Z1 and nn are chosen in such a way that the metal-ligand complex of Formula (i) is overall neutral;

wherein each Q¹ and Q¹⁰ independently is selected from the group consisting of (C₆-C₄₀)aryl, substituted (C₆-C₄₀)aryl, (C₃-C₄₀)heteroaryl, and substituted (C₃-C₄₀)heteroaryl;

wherein each Q², Q³, Q⁴, Q⁷, Q⁸, and Q⁹ independently is selected from a group consisting of hydrogen, (C₁-C₄₀)hydrocarbyl, substituted (C₁-C₄₀)hydrocarbyl, (C₁-C₄₀)heterohydrocarbyl, substituted (C₁-C₄₀)heterohydrocarbyl, halogen, and nitro (NO₂);

wherein each Q⁵ and Q⁶ independently is selected from the group consisting of a (C₁-C₄₀)alkyl, substituted (C₁-C₄₀)alkyl, and [(Si)₁—(C+Si)₄₀] substituted organosilyl;

wherein each N independently is nitrogen;

optionally, two or more of the Q¹⁻⁵ groups can combine together to form a ring structure, with such ring structure having from 5 to 16 atoms in the ring excluding any hydrogen atoms; and

optionally, two or more of the Q⁶⁻¹⁰ groups can combine together to form a ring structure, with such ring structure having from 5 to 16 atoms in the ring excluding any hydrogen atoms.

The metal ligand complex of Formula (i) above, and all specific embodiments thereof herein, is intended to include every possible stereoisomer, including coordination isomers, thereof.

The metal ligand complex of Formula (i) above provides for homoleptic as well as heteroleptic procatalyst components.

In an alternative embodiment, each of the (C₁-C₄₀) hydrocarbyl and (C₁-C₄₀) heterohydrocarbyl of any one or more of Q¹, Q², Q³, Q⁴, Q⁵, Q⁶, Q⁷, Q⁸, Q⁹ and Q¹⁰ each independently is unsubstituted or substituted with one or more R^{S} substituents, and wherein each R^{S} independently is a halogen atom, polyfluoro substitution, perfluoro substitution, unsubstituted (C₁-C₁₈)alkyl, (C₆-C₁₈)aryl, F₃C, FCH₂O, F₂HCO, F₃CO, (R^{C1})₃Si, (R^{C1})₃Ge, (R^{C1})O, (R^{C1})S, (R^{C1})S(O), (R^{C1})S(O)₂, (R^{C1})₂P, (R^{C1})₂N, (R^{C1})₂C═N, NC, NO₂, (R^{C1})C(O)O, (R^{C1})OC(O), (R^{C1})C(O)N(R^{C1}), or (R^{C1})₂NC(O), or two of the R^{S} are taken together to form an unsubstituted (C₁-C₁₈)alkylene where each R^{S} independently is an unsubstituted (C₁-C₁₈)alkyl, and wherein independently each R^{C1} is hydrogen, unsubstituted (C₁-C₁₈)hydrocarbyl or an unsubstituted (C₁-C₁₈)heterohydrocarbyl, or absent (e.g., absent when N comprises —N═). In particular embodiments, Q⁵ and Q⁶ are each independently (C₁-C₄₀) primary or secondary alkyl groups with respect to their connection to the amine nitrogen of the parent ligand structure. The terms primary and secondary alkyl groups are given their usual and customary meaning herein; i.e., primary indicating that the carbon atom directly linked to the ligand nitrogen bears at least two hydrogen atoms and secondary indicates that the carbon atom directly linked to the ligand nitrogen bears only one hydrogen atom.

Optionally, two or more Q₁₋₅ groups or two or more Q₆₋₁₀ groups each independently can combine together to form ring structures, with such ring structures having from 5 to 16 atoms in the ring excluding any hydrogen atoms.

In preferred embodiments, Q⁵ and Q⁶ are each independently (C₁-C₄₀) primary or secondary alkyl groups and most preferably, Q⁵ and Q⁶ are each independently propyl, isopropyl, neopentyl, hexyl, isobutyl and benzyl.

In particular embodiments, Q¹ and Q¹⁰ of the olefin polymerization procatalyst of Formula (i) are substituted phenyl groups; as shown in Formula (ii),

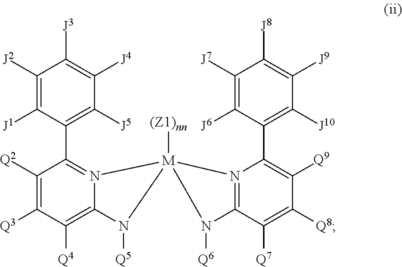

wherein J¹-J¹⁰ are each independently selected from the group consisting of R^{s} substituents and hydrogen; and wherein each R^{S} independently is a halogen atom, polyfluoro substitution, perfluoro substitution, unsubstituted (C₁-C₁₈)alkyl, (C₆-C₁₈)aryl, F₃C, FCH₂O, F₂HCO, F₃CO, (R^{C1})₃Si, (R^{C1})₃Ge, (R^{C1})O, (R^{C1})S, (R^{C1})S(O), (R^{C1})S(O)₂, (R^{C1})₂P, (R^{C1})₂N, (R^{C1})₂C═N, NC, NO₂, (R^{C1})C(O)O, (R^{C1})OC(O), (R^{C1})C(O)N(R^{C1}), or (R^{C1})₂NC(O), or two of the R^{S} are taken together to form an unsubstituted (C₁-C₁₈)alkylene where each R^{S} independently is an unsubstituted (C₁-C₁₈)alkyl, and wherein independently each R^{C1} is hydrogen, unsubstituted (C₁-C₁₈)hydrocarbyl or an unsubstituted (C₁-C₁₈)heterohydrocarbyl, or absent (e.g., absent when N comprises —N═). More preferably, J¹, J⁵, J⁶ and J¹⁰ of Formula (ii) are each independently selected from the group consisting of halogen atoms, (C₁-C₈) alkyl groups, and (C₁-C₈) alkoxyl groups. Most preferably, J¹, J⁵, J⁶ and J¹⁰ of Formula (ii) are each independently methyl; ethyl or isopropyl.

When used to describe certain carbon atom-containing chemical groups (e.g., (C₁-C₄₀)alkyl), the parenthetical expression (C₁-C₄₀) can be represented by the form “(Cₓ-C_{y}),” which means that the unsubstituted version of the chemical group comprises from a number x carbon atoms to a number y carbon atoms, wherein each x and y independently is an integer as described for the chemical group. The R^{S} substituted version of the chemical group can contain more than y carbon atoms depending on nature of R^{S}. Thus, for example, an unsubstituted (C₁-C₄₀)alkyl contains from 1 to 40 carbon atoms (x=1 and y=40). When the chemical group is substituted by one or more carbon atom-containing R^{S} substituents, the substituted (Cₓ-C_{y}) chemical group may comprise more than y total carbon atoms; i.e., the total number of carbon atoms of the carbon atom-containing substituent(s)-substituted (Cₓ-C_{y}) chemical group is equal to y plus the sum of the number of carbon atoms of each of the carbon atom-containing substituent(s). Any atom of a chemical group that is not specified herein is understood to be a hydrogen atom.

In some embodiments, each of the chemical groups (e.g., Q¹⁻¹⁰) of the metal-ligand complex of Formula (i) may be unsubstituted, that is, can be defined without use of a substituent R^{S}, provided the above-mentioned conditions are satisfied. In other embodiments, at least one of the chemical groups of the metal-ligand complex of Formula (i) independently contain one or more of the substituents R^{S}. Where the compound contains two or more substituents R^{S}, each R^{S} independently is bonded to a same or different substituted chemical group. When two or more R^{S} are bonded to a same chemical group, they independently are bonded to a same or different carbon atom or heteroatom, as the case may be, in the same chemical group up to and including persubstitution of the chemical group.

The term “persubstitution” means each hydrogen atom (H) bonded to a carbon atom or heteroatom of a corresponding unsubstituted compound or functional group, as the case may be, is replaced by a substituent (e.g., R^{S}). The term “polysubstitution” means each of at least two, but not all, hydrogen atoms (H) bonded to carbon atoms or heteroatoms of a corresponding unsubstituted compound or functional group, as the case may be, is replaced by a substituent (e.g., R^{S}). The term “monosubstitution” means that only one hydrogen atom (H) bonded to a carbon atom or heteroatom of a corresponding unsubstituted compound or functional group, as the case may be, is replaced by a substituent (e.g., R^{S}).

As used herein, the definitions of the terms hydrocarbyl, heterohydrocarbyl, hydrocarbylene, heterohydrocarbylene, alkyl, alkylene, heteroalkyl, heteroalkylene, aryl, arylene, heteroaryl, heteroarylene, cycloalkyl, cycloalkylene, heterocycloalkyl, and heterocycloalkylene are intended to include every possible stereoisomer.

As used herein, the term “(C₁-C₄₀)hydrocarbyl” means a hydrocarbon radical of from 1 to 40 carbon atoms and the term “(C₁-C₄₀)hydrocarbylene” means a hydrocarbon diradical of from 1 to 40 carbon atoms, wherein each hydrocarbon radical and diradical independently is aromatic (6 carbon atoms or more) or non-aromatic, saturated or unsaturated, straight chain or branched chain, cyclic (including mono- and polycyclic, fused and non-fused polycyclic, including bicyclic; 3 carbon atoms or more) or acyclic, or a combination of two or more thereof; and each hydrocarbon radical and diradical independently is the same as or different from another hydrocarbon radical and diradical, respectively, and independently is unsubstituted or substituted by one or more R^{S}.

Preferably, a (C₁-C₄₀)hydrocarbyl independently is an unsubstituted or substituted (C₁-C₄₀)alkyl, (C₃-C₄₀)cycloalkyl, (C₃-C₂₀)cycloalkyl-(C₁-C₂₀)alkylene, (C₆-C₄₀)aryl, or (C₆-C₂₀)aryl-(C₁-C₂₀)alkylene. All individual values and subranges from 1 to 40 carbons in the (C₁-C₄₀)hydrocarbyl are included and disclosed herein; for example, the number of carbon atoms in the (C₁-C₄₀)hydrocarbyl may range from an upper limit of 40 carbon atoms, preferably 30 carbon atoms, more preferably 20 carbon atoms, more preferably 15 carbon atoms, more preferably 12 carbon atoms and most preferably 10 carbon atoms. For example, the (C₁-C₄₀)hydrocarbyl includes (C₁-C₄₀)hydrocarbyl groups, (C₁-C₃₀)hydrocarbyl) groups, (C₁-C₂₀)hydrocarbyl) groups, (C₁-C₁)hydrocarbyl) groups, (C₁-C₁₂)hydrocarbyl) groups, (C₁-C₁₀)hydrocarbyl) groups, (C₁₀-C₃₀)hydrocarbyl) groups, (C₁₅-C₄₀)hydrocarbyl) groups, (C₅-C₂₅)hydrocarbyl) groups, or (C₅-C₂₅)hydrocarbyl) groups.

The term “(C₁-C₄₀)alkyl” means a saturated straight or branched hydrocarbon radical of from 1 to 40 carbon atoms, that is unsubstituted or substituted by one or more R^{S}. Examples of unsubstituted (C₁-C₄₀)alkyl are unsubstituted (C₁-C₂₀)alkyl; unsubstituted (C₁-C₁₀)alkyl; unsubstituted (C₁-C₅)alkyl; methyl; ethyl; 1-propyl; 2-propyl; 2,2-dimethylpropyl, 1-butyl; 2-butyl; 2-methylpropyl; 1,1-dimethylethyl; 1-pentyl; 1-hexyl; 2-ethylhexyl, 1-heptyl; 1-nonyl; and 1-decyl; 2,2,4-trimethylpentyl. Examples of substituted (C₁-C₄₀)alkyl are substituted (C₁-C₂₀)alkyl; substituted (C₁-C₁₀)alkyl; trifluoromethyl; trimethylsilylmethyl; methoxymethyl; dimethylaminomethyl; trimethylgermylmethyl; phenylmethyl (benzyl); 2-phenyl-2,2-methylethyl; 2-(dimethylphenylsilyl)ethyl; and dimethyl(t-butyl)silylmethyl.

The term “(C₆-C₄₀)aryl” means an unsubstituted or substituted (by one or more R^{S}) mono-, bi- or tricyclic aromatic hydrocarbon radical of from 6 to 40 carbon atoms, of which at least from 6 to 14 of the carbon atoms are aromatic ring carbon atoms, and the mono-, bi- or tricyclic radical comprises 1, 2 or 3 rings, respectively; wherein one ring is aromatic and the optional second and third rings independently are fused or non-fused and the second and third rings are each independently optionally aromatic. Examples of unsubstituted (C₆-C₄₀)aryl are unsubstituted (C₆-C₂₀)aryl; unsubstituted (C₆-C₁₈)aryl; phenyl; biphenyl; ortho-terphenyl; meta-terphenyl; fluorenyl; tetrahydrofluorenyl; indacenyl; hexahydroindacenyl; indenyl; dihydroindenyl; naphthyl; tetrahydronaphthyl; phenanthrenyl and triptycenyl. Examples of substituted (C₆-C₄₀)aryl are substituted (C₆-C₂₀)aryl; substituted (C₆-C₁₈)aryl; 2,6-bis[(C₁-C₂₀)alkyl]-phenyl; 2-(C₁-C₅)alkyl-phenyl; 2,6-bis(C₁-C₅)alkyl-phenyl; 2,4,6-tris(C₁-C₅)alkyl-phenyl; polyfluorophenyl; pentafluorophenyl; 2,6-dimethylphenyl; 2,6-diisopropylphenyl; 2,4,6-triisopropylphenyl; 2,4,6-trimethylphenyl; 2-methyl-6-trimethylsilylphenyl; 2-methyl-4,6-diisopropylphenyl; 4-methoxyphenyl; and 4-methoxy-2,6-dimethylphenyl.

The term “(C₃-C₄₀)cycloalkyl” means a saturated cyclic hydrocarbon radical of from 3 to 40 carbon atoms that is unsubstituted or substituted by one or more R^{S}. Other cycloalkyl groups (e.g., (C₃-C₁₂)alkyl)) are defined in an analogous manner. Examples of unsubstituted (C₃-C₄₀)cycloalkyl are unsubstituted (C₃-C₂₀)cycloalkyl; unsubstituted (C₃-C₁₀)cycloalkyl; cyclopropyl; cyclobutyl; cyclopentyl; cyclohexyl; cycloheptyl; cyclooctyl; cyclononyl; cyclodecyl; cyclopentyl; cyclohexyl; octahydroindenyl; bicyclo[4.4.0]decyl; bicyclo[2.2.1]heptyl; and tricyclo[3.3.1.1]decyl. Examples of substituted (C₃-C₄₀)cycloalkyl are substituted (C₃-C₂₀)cycloalkyl; substituted (C₃-C₁₀)cycloalkyl; 2-methylcyclohexyl; and perfluorocyclohexyl.

Examples of (C₁-C₄₀)hydrocarbylene are unsubstituted or substituted (C₃-C₄₀)hydrocarbylene; (C₆-C₄₀)arylene, (C₃-C₄₀)cycloalkylene, and (C₃-C₄₀)alkylene (e.g., (C3-C20)alkylene). In some embodiments, the diradicals are on the terminal atoms of the hydrocarbylene as in a 1,3-alpha, omega diradical (e.g., —CH₂CH₂CH₂—) or a 1,5-alpha, omega diradical with internal substitution (e.g., —CH₂CH₂CH(CH₃)CH₂CH₂—). In other embodiments, the diradicals are on the non-terminal atoms of the hydrocarbylene as in a C₇ 2,6-diradical (e.g.,

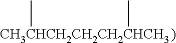

or a C₇ 2,6-diradical with internal substitution (e.g.,

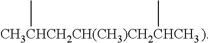

The terms “(C₁-C₄₀)heterohydrocarbyl” and “(C₁-C₄₀)heterohydrocarbylene” mean a heterohydrocarbon radical or diradical, respectively, of from 1 to 40 carbon atoms, and each heterohydrocarbon independently has one or more heteroatoms or heteroatomic groups O; S; N; S(O); S(O)₂; S(O)₂N; Si(R^{C1})₂; Ge(R^{C1})₂; P(R^{C1}); P(O)(R^{C1}); and N(R^{C1}), wherein independently each R^{C1} is hydrogen, unsubstituted (C₁-C₁₈)hydrocarbyl or an unsubstituted (C₁-C₁₈)heterohydrocarbyl, or absent (e.g., absent when N comprises —N═). Each (C₁-C₄₀)heterohydrocarbyl and (C₁-C₄₀)heterohydrocarbylene independently is unsubstituted or substituted (by one or more R^{S}), aromatic or non-aromatic, saturated or unsaturated, straight chain or branched chain, cyclic (including mono- and poly-cyclic, fused and non-fused polycyclic) or acyclic, or a combination of two or more thereof; and each is respectively the same as or different from another.

The term “(C₁-C₄₀)alkylene” means a saturated or unsaturated straight chain or branched chain diradical of from 1 to 40 carbon atoms that is unsubstituted or substituted by one or more R^{S}. Examples of unsubstituted (C₁-C₄₀)alkylene are unsubstituted (C₃-C₂₀)alkylene, including unsubstituted 1,3-(C₃-C₁₀)alkylene; 1,4-(C₄-C₁₀)alkylene; —(CH₂)₃—; —(CH₂)₄—; —(CH₂)—; —(CH₂)₆—; —(CH₂)₇—; —(CH₂)₈—; and —(CH₂)₄CH(CH₃)—. Examples of substituted (C₁-C₄₀)alkylene are substituted (C₃-C₂₀)alkylene; —CF₂CF₂CF₂—; and —(CH₂)₁₄C(CH₃)₂(CH₂)₅— (i.e., a 6,6-dimethyl substituted normal-1,20-eicosylene). Since as mentioned previously two R^{S} may be taken together to form a (C₁-C₄₀)alkylene, examples of substituted (C₁-C₄₀)alkylene also include 1,2-bis(methylene)cyclopentane; 1,2-bis(methylene)cyclohexane; 2,3-bis(methylene)-7,7-dimethyl-bicyclo[2.2.1]heptane; and 2,3-bis(methylene)bicyclo[2.2.2]octane.

The term “(C₃-C₄₀)cycloalkylene” means a cyclic diradical (i.e., the radicals are on ring atoms) of from 3 to 40 carbon atoms that is unsubstituted or substituted by one or more R^{S}. Connection of the chelating substituents to a cycloalkylene Q³ group of Formula (i) must also satisfy the requirement that there be at least three atoms in the shortest chain connecting the bridged N atoms of Formula (i). Examples of unsubstituted (C₃-C₄₀)cycloalkylene are 1,3-cyclobutylene, 1,3-cyclopentylene, and 1,4-cyclohexylene. Examples of substituted (C₃-C₄₀)cycloalkylene are 2-trimethylsilyl-1,4-cyclohexylene and 1,2-dimethyl-1,3-cyclohexylene.

Preferably, the (C₁-C₄₀)heterohydrocarbyl independently is unsubstituted or substituted (C₁-C₄₀)heteroalkyl, (C₁-C₄₀)hydrocarbyl-O—, (C₁-C₄₀)hydrocarbyl-S—, (C₁-C₄₀)hydrocarbyl-S(O)—, (C₁-C₄₀)hydrocarbyl-S(O)₂—, (C₁-C₄₀)hydrocarbyl-Si(R^{C1})₂—, (C₁-C₄₀)hydrocarbyl-Ge(R^{C1})₂—, (C₁-C₄₀)hydrocarbyl-N(R^{C1})—, (C₁-C₄₀)hydrocarbyl-P(R^{C1}), (C₂-C₄₀)heterocycloalkyl, (C₂-C₁₉)heterocycloalkyl-(C₁-C₂₀)alkylene, (C₃-C₂₀)cycloalkyl-(C₁-C₁₉)heteroalkylene, (C₂-C₁₉)heterocycloalkyl-(C₁-C₂₀)heteroalkylene, (C₁-C₄₀)heteroaryl, (C₁-C₁₉)heteroaryl-(C₁-C₂₀)alkylene, (C₆-C₂₀)aryl-(C₁-C₁₉)heteroalkylene, or (C₁-C₁₉)heteroaryl-(C₁-C₂₀)heteroalkylene, wherein independently each R^{C1} is hydrogen, unsubstituted (C₁-C₁₈)hydrocarbyl or an unsubstituted (C₁-C₁₈)heterohydrocarbyl, or absent (e.g., absent when N comprises —N═). The term “(C₁-C₄₀)heteroaryl” means an unsubstituted or substituted (by one or more R^{S}) mono-, bi- or tricyclic heteroaromatic hydrocarbon radical of from 1 to 40 total carbon atoms and from 1 to 6 heteroatoms, and the mono-, bi- or tricyclic radical comprises 1, 2 or 3 rings, respectively, wherein one ring is heteroaromatic and the optional second and third rings independently are fused or non-fused; and the second or third rings are each independently optionally heteroaromatic. Other heteroaryl groups (e.g., (C₃-C₁₂)heteroaryl)) are defined in an analogous manner. The monocyclic heteroaromatic hydrocarbon radical is a 5-membered or 6-membered ring. The 5-membered ring has from 1 to 4 carbon atoms and from 4 to 1 heteroatoms, respectively, each heteroatom being O, S, N, or P, and preferably O, S, or N. Examples of 5-membered ring heteroaromatic hydrocarbon radical are pyrrol-1-yl; pyrrol-2-yl; furan-3-yl; thiophen-2-yl; pyrazol-1-yl; isoxazol-2-yl; isothiazol-5-yl; imidazol-2-yl; oxazol-4-yl; thiazol-2-yl; 1,2,4-triazol-1-yl; 1,3,4-oxadiazol-2-yl; 1,3,4-thiadiazol-2-yl; tetrazol-1-yl; tetrazol-2-yl; and tetrazol-5-yl. The 6-membered ring has 3 to 5 carbon atoms and 1 to 3 heteroatoms, the heteroatoms being N or P, and preferably N. Examples of 6-membered ring heteroaromatic hydrocarbon radical are pyridine-2-yl; pyrimidin-2-yl; and pyrazin-2-yl, triazinyl. The bicyclic heteroaromatic hydrocarbon radical preferably is a fused 5,6- or 6,6-ring system. Examples of the fused 5,6-ring system bicyclic heteroaromatic hydrocarbon radical are indol-1-yl; and benzimidazole-1-yl. Examples of the fused 6,6-ring system bicyclic heteroaromatic hydrocarbon radical are quinolin-2-yl; and isoquinolin-1-yl. The tricyclic heteroaromatic hydrocarbon radical preferably is a fused 5,6,5-; 5,6,6-; 6,5,6-; or 6,6,6-ring system. An example of the fused 5,6,5-ring system is 1,7-dihydropyrrolo[3,2-]indol-1-yl. An example of the fused 5,6,6-ring system is 1H-benzo[f]indol-1-yl. An example of the fused 6,5,6-ring system is 9H-carbazol-9-yl. An example of the fused 6,5,6-ring system is 9H-carbazol-9-yl. An example of the fused 6,6,6-ring system is acrydin-9-yl.

The term “[(Si)₁—(C+Si)₄₀] substituted organosilyl” means a substituted silyl radical with 1 to 40 silicon atoms and 0 to 39 carbon atoms such that the total number of carbon plus silicon atoms is between 1 and 40. Examples of [(Si)₁—(C+Si)₄₀] substituted organosilyl include trimethylsilyl, triisopropylsilyl, dimethylphenylsilyl, diphenylmethylsilyl, triphenylsilyl, and triethylsilyl.

In some embodiments the (C₃-C₄₀)heteroaryl is 2,7-disubstituted carbazolyl or 3,6-disubstituted carbazolyl, more preferably wherein each R^{S} independently is phenyl, methyl, ethyl, isopropyl, or tertiary-butyl, still more preferably 2,7-di(tertiary-butyl)-carbazolyl, 3,6-di(tertiary-butyl)-carbazolyl, 2,7-di(tertiary-octyl)-carbazolyl, 3,6-di(tertiary-octyl)-carbazolyl, 2,7-diphenylcarbazolyl, 3,6-diphenylcarbazolyl, 2,7-bis(2,4,6-trimethylphenyl)-carbazolyl or 3,6-bis(2,4,6-trimethylphenyl)-carbazolyl.

As used herein, “heteroalkyl” and “heteroalkylene” groups are saturated straight or branched chain radicals or diradicals, respectively, containing (C₁-C₄₀)carbon atoms, and one or more of the heteroatoms or heteroatomic groups O; S; N; S(O); S(O)₂; S(O)₂N; Si(R¹)₂; Ge(R^{C1})₂; P(R^{C1}); P(O)(R^{C1}); and N(R^{C1}), as defined above, wherein each of the heteroalkyl and heteroalkylene groups independently are unsubstituted or substituted by one or more R^{S}, and wherein independently each R^{C1} is hydrogen, unsubstituted (C₁-C₁₈)hydrocarbyl or an unsubstituted (C₁-C₁₈)heterohydrocarbyl, or absent (e.g., absent when N comprises —N═). Examples of substituted and unsubstituted heteroalkyl groups are methoxyl; ethoxyl; trimethylsilyl; dimethylphenylsilyl; tert-butyldimethylsilyl; and dimethylamino.

A heteroalkyl group may optionally be cyclic, i.e. a heterocycloalkyl group. Examples of unsubstituted (C₃-C₄₀)heterocycloalkyl are unsubstituted (C₃-C₂₀)heterocycloalkyl, unsubstituted (C₃-C₁₀)heterocycloalkyl, oxetan-2-yl, tetrahydrofuran-3-yl, pyrrolidin-1-yl, tetrahydrothiophen-S,S-dioxide-2-yl, morpholin-4-yl, 1,4-dioxan-2-yl, hexahydroazepin-4-yl, 3-oxa-cyclooctyl, 5-thio-cyclononyl, and 2-aza-cyclodecyl.

The term “halogen atom” means fluorine atom (F), chlorine atom (Cl), bromine atom (Br), or iodine atom (I) radical. Preferably each halogen atom independently is the Br, F, or Cl radical, and more preferably the F or Cl radical. The term “halide” means fluoride (F⁻), chloride (Cl⁻), bromide (Br⁻), or iodide (I⁻) anion.

Preferably, there are no O—O, S—S, or O—S bonds, other than O—S bonds in an S(O) or S(O)₂ diradical functional group, in the metal-ligand complex of Formula (i). More preferably, there are no O—O, P—P, S—S, or O—S bonds, other than O—S bonds in an S(O) or S(O)₂ diradical functional group, in the metal-ligand complex of Formula (i).

The term “saturated” means lacking carbon-carbon double bonds, carbon-carbon triple bonds, and (in heteroatom-containing groups) carbon-nitrogen, carbon-phosphorous, and carbon-silicon double bonds and carbon-nitrogen triple bonds. Where a saturated chemical group is substituted by one or more substituents R^{S}, one or more double and/or triple bonds optionally may or may not be present in substituents R^{S}. The term “unsaturated” means containing one or more carbon-carbon double bonds, carbon-carbon triple bonds, and (in heteroatom-containing groups) carbon-nitrogen, carbon-phosphorous, and carbon-silicon double bonds, and carbon nitrogen triple bonds, not including any such double or triple bonds that may be present in substituents R^{S}, if any, or in (hetero)aromatic rings, if any.

M is titanium, zirconium, or hafnium. In one embodiment, M is titanium. In another embodiment, M is zirconium. In another embodiment, M is hafnium. In some embodiments, M is in a formal oxidation state of +2, +3, or +4. Each Z independently is a monodentate or polydentate ligand that is neutral, monoanionic, or dianionic. Z1 and nn are chosen in such a way that the metal-ligand complex of Formula (i) is, overall, neutral. In some embodiments each Z1 independently is the monodentate ligand. In one embodiment when there are two or more Z1 monodentate ligands, each Z1 is the same. In some embodiments the monodentate ligand is the monoanionic ligand. The monoanionic ligand has a net formal oxidation state of −1. Each monoanionic ligand may independently be hydride, (C₁-C₄₀)hydrocarbyl carbanion, (C₁-C₄₀)heterohydrocarbyl carbanion, halide, nitrate, carbonate, phosphate, borate, borohydride, sulfate, HC(O)O—, alkoxide or aryloxide (RO⁻), (C₁-C₄₀)hydrocarbylC(O)O⁻, HC(O)N(H)⁻, (C₁-C₄₀)hydrocarbylC(O)N(H)⁻, (C₁-C₄₀)hydrocarbylC(O)N((C₁-C₂₀)hydrocarbyl)⁻, R^{K}R^{L}B⁻, R^{K}R^{L}N⁻, R^{K}O⁻, R^{K}S⁻, R^{K}R^{L}P⁻, or R^{M}R^{K}R^{L}Si⁻, wherein each R^{K}, R^{L}, and R^{M} independently is hydrogen, (C₁-C₄₀)hydrocarbyl, or (C₁-C₄₀)heterohydrocarbyl, or R^{K} and R^{L} are taken together to form a (C₂-C₄₀)hydrocarbylene or (C₁-C₄₀)heterohydrocarbylene and R^{M} is as defined above.

In some embodiments at least one monodentate ligand of Z1 independently is the neutral ligand. In one embodiment, the neutral ligand is a neutral Lewis base group that is R^{X1}NR^{K}R^{L}, R^{K}OR^{L}, R^{K}SR^{L}, or R^{X}PR^{K}R^{L}, wherein each R^{X1} independently is hydrogen, (C₁-C₄₀)hydrocarbyl, [(C₁-C₁₀)hydrocarbyl]₃Si, [(C₁-C₁₀)hydrocarbyl]₃Si(C₁-C₁₀)hydrocarbyl, or (C₁-C₄₀)heterohydrocarbyl and each R^{K} and R^{L} independently is as defined above.

In some embodiments, each Z1 is a monodentate ligand that independently is a halogen atom, unsubstituted (C₁-C₂₀)hydrocarbyl, unsubstituted (C₁-C₂₀)hydrocarbylC(O)O—, or R^{K}R^{L}N— wherein each of R^{K} and R^{L} independently is an unsubstituted (C₁-C₂₀)hydrocarbyl. In some embodiments each monodentate ligand Z1 is a chlorine atom, (C₁-C₁₀)hydrocarbyl (e.g., (C₁-C₆)alkyl or benzyl), unsubstituted (C₁-C₁₀)hydrocarbylC(O)O—, or R^{K}R^{L}N— wherein each of R^{K} and R^{L} independently is an unsubstituted (C₁-C₁₀)hydrocarbyl.

In some embodiments there are at least two Z1s and the two Z1s are taken together to form the bidentate ligand. In some embodiments the bidentate ligand is a neutral bidentate ligand. In one embodiment, the neutral bidentate ligand is a diene of Formula (R^{D1})₂C═C(R^{D1})—C(R^{D1})═C(R^{D1})₂, wherein each R^{D1} independently is H, unsubstituted (C₁-C₆)alkyl, phenyl, or naphthyl. In some embodiments the bidentate ligand is a monoanionic-mono(Lewis base) ligand. The monoanionic-mono(Lewis base) ligand may be a 1,3-dionate of Formula (D): R^{E1}—C(O⁻)═CH—C(═O)—R^{E1} (D), wherein each R^{E1} independently is H, unsubstituted (C₁-C₆)alkyl, phenyl, or naphthyl. In some embodiments the bidentate ligand is a dianionic ligand. The dianionic ligand has a net formal oxidation state of −2. In one embodiment, each dianionic ligand independently is carbonate, oxalate (i.e., ⁻O₂CC(O)O⁻), (C₂-C₄)hydrocarbylene dicarbanion, (C₁-C₄₀)heterohydrocarbylene dicarbanion, phosphate, or sulfate.

As previously mentioned, number and charge (neutral, monoanionic, dianionic) of Z1 are selected depending on the formal oxidation state of M such that the metal-ligand complex of Formula (i) is, overall, neutral.

In some embodiments each Z1 is the same, wherein each Z is methyl; isobutyl; neopentyl; neophyl; trimethylsilylmethyl; phenyl; benzyl; or chloro. In some embodiments nn is 2 and each Z1 is the same.

In some embodiments at least two Z1 are different. In some embodiments, each Z1 is a different one of methyl; isobutyl; neopentyl; neophyl; trimethylsilylmethyl; phenyl; benzyl; and chloro.

In one embodiment, the metal-ligand complex of Formula (i) is a mononuclear metal complex. In another embodiment, olefin polymerization catalyst systems of the present invention demonstrate reversible chain transfer indicative of chain shuttling behavior in the presence of appropriate chain shuttling agents. Such combination of attributes is particularly of interest in the preparation of olefin block copolymers. In general, the ability to tune alpha-olefin incorporation and thus short-chain branching distribution is critical to accessing materials with performance differentiation.

In some embodiments the metal-ligand complex of Formula (i) is a metal-ligand complex of Formula (ii):

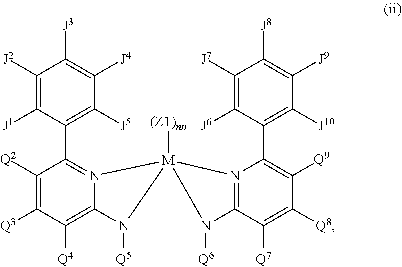

wherein J¹-J¹⁰ are each independently selected from the group consisting of R^{s} substituents (as defined above) and hydrogen.

In a particular embodiment, J¹, J⁵, J⁶ and J¹⁰ of Formula (ii) are each independently selected from the group consisting of halogen atoms, (C₁-C₈) alkyl groups, and (C₁-C₈) alkoxyl groups.

Structures exemplifying metal-ligand complexes described by Formula (i) are shown below:

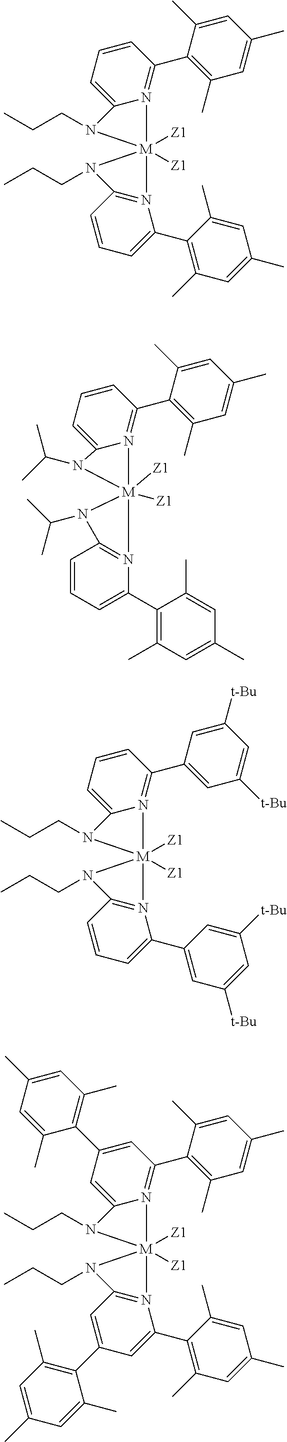

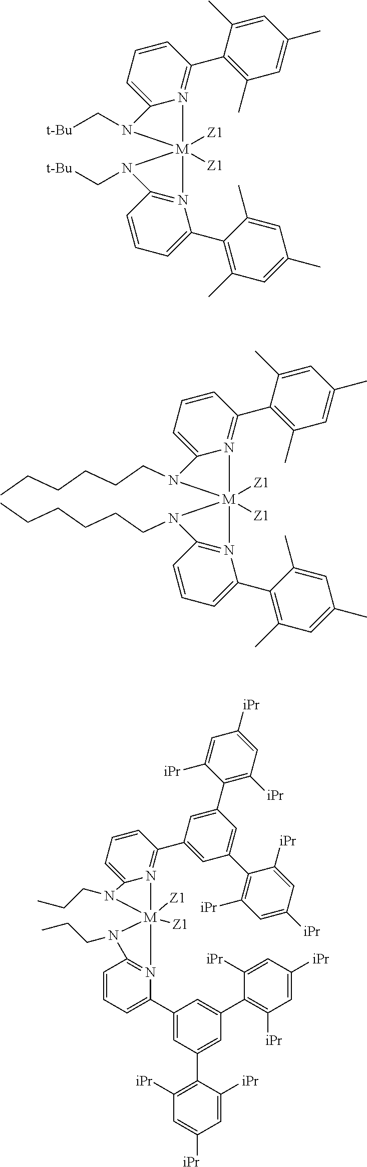

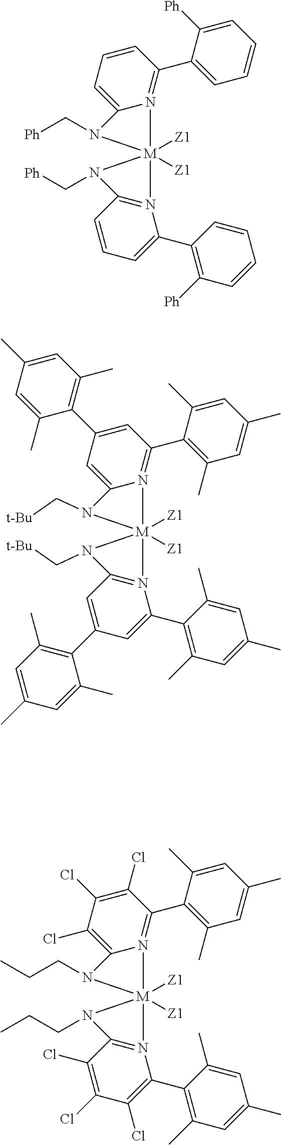

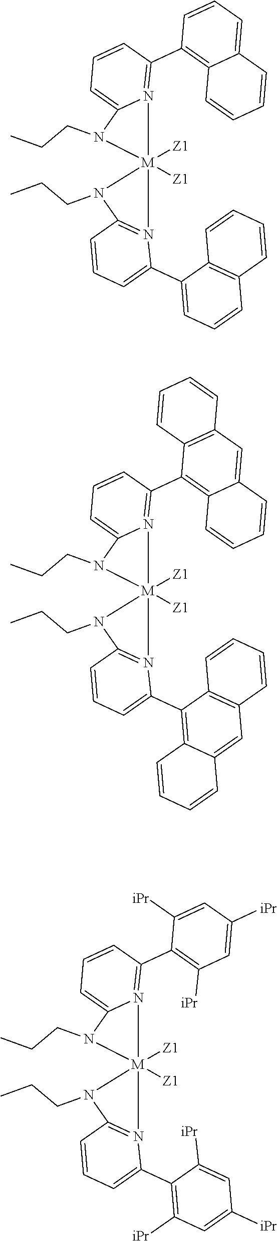

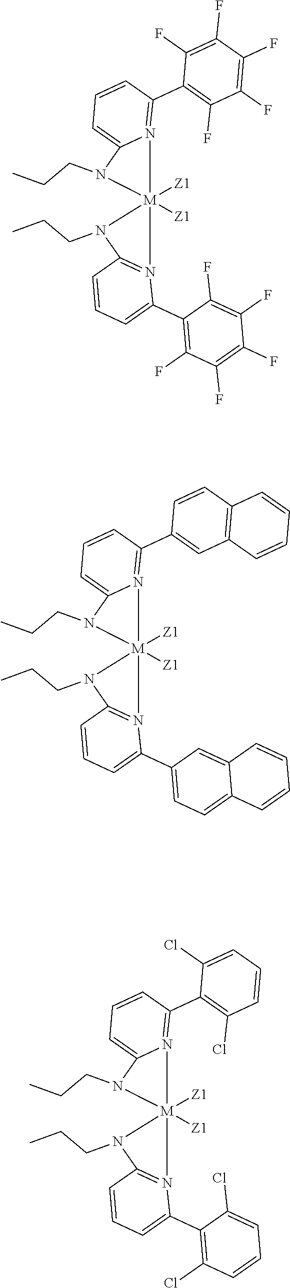

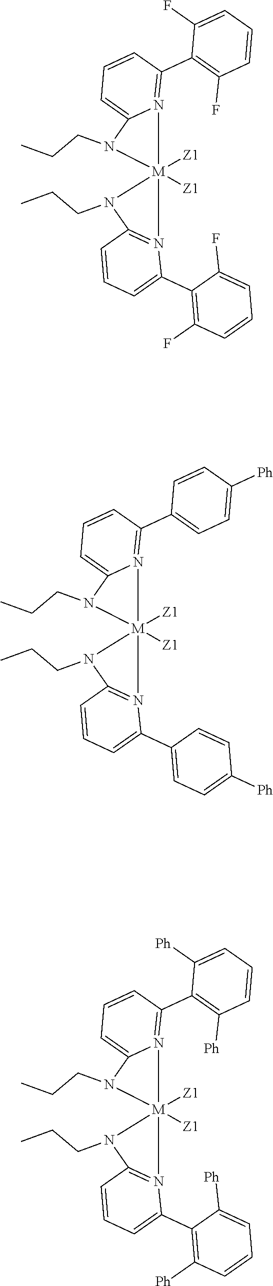

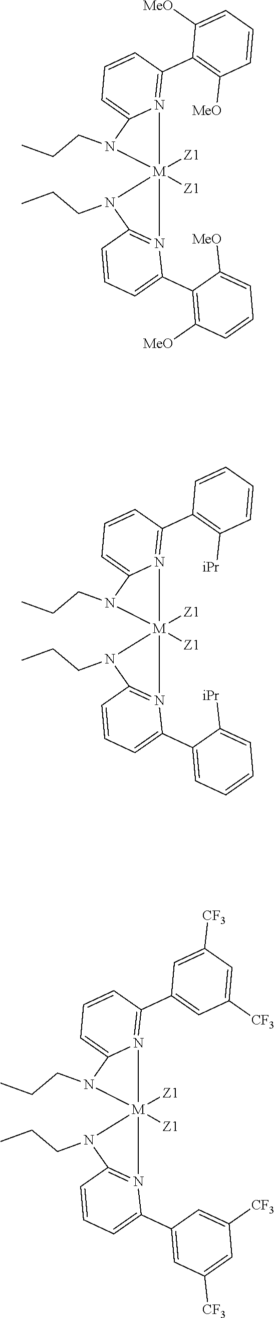

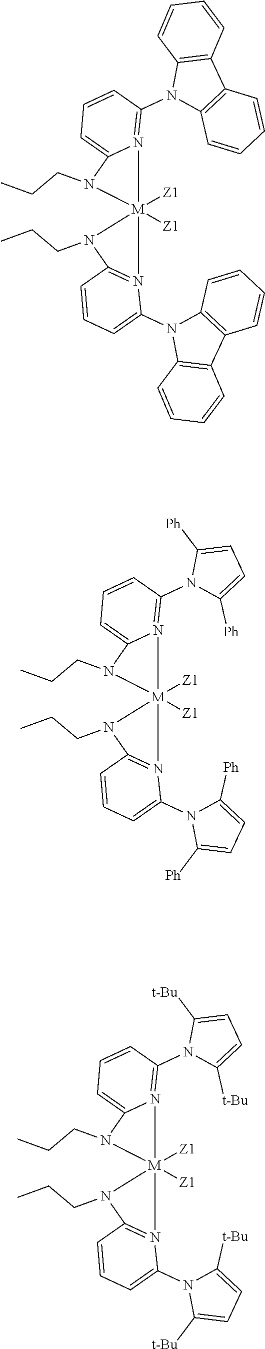

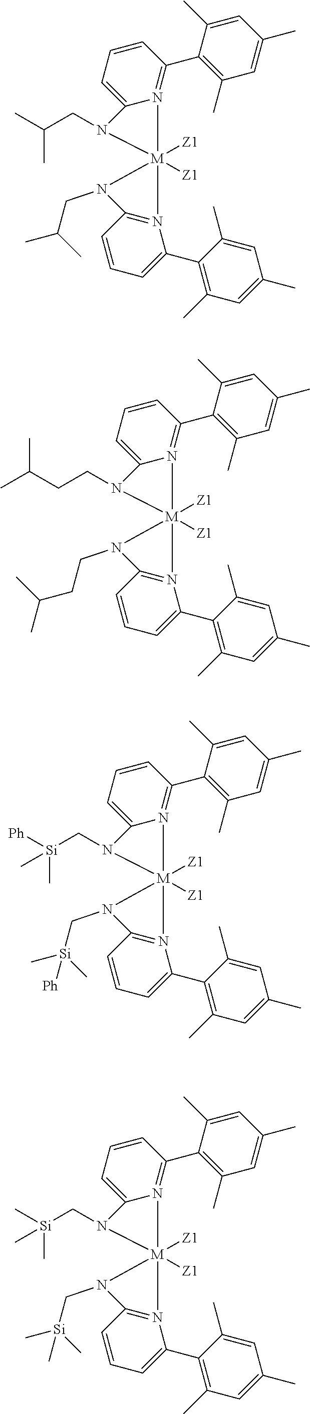

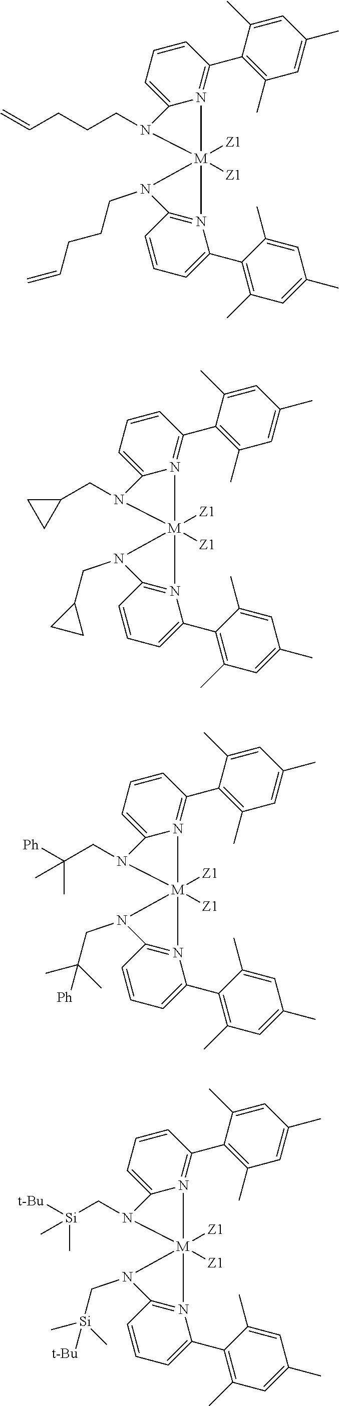

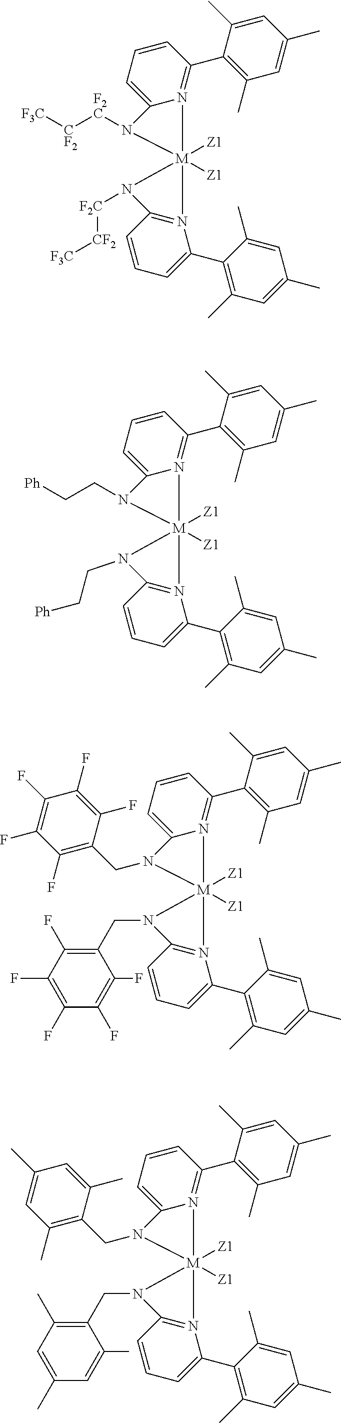

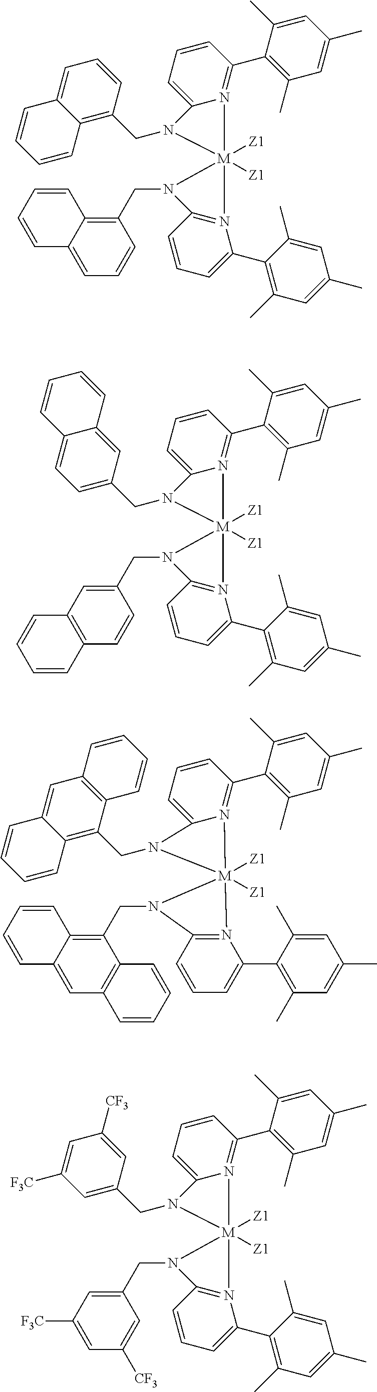

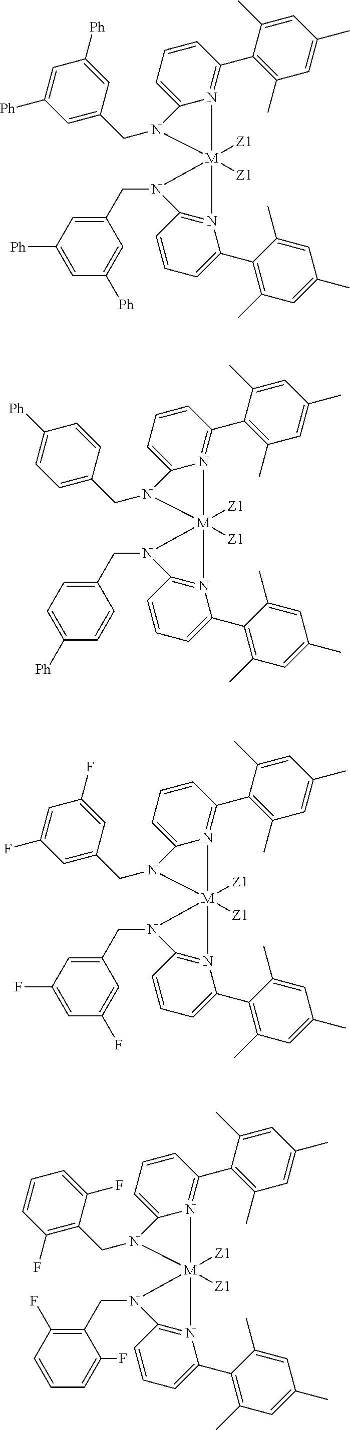

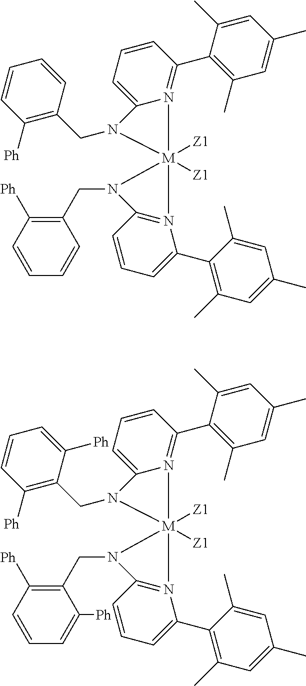

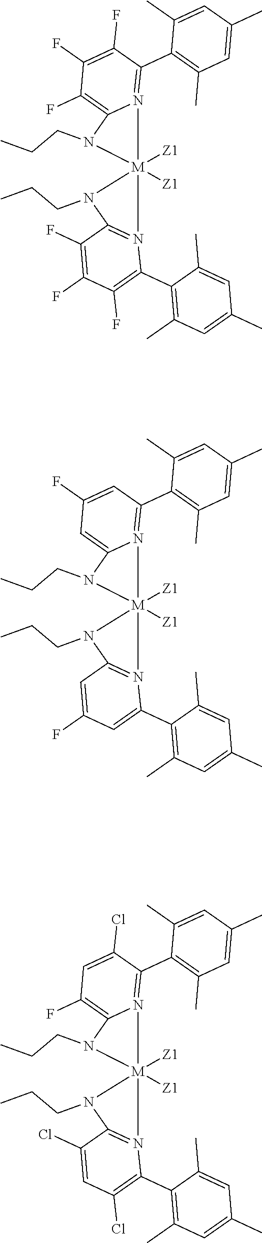

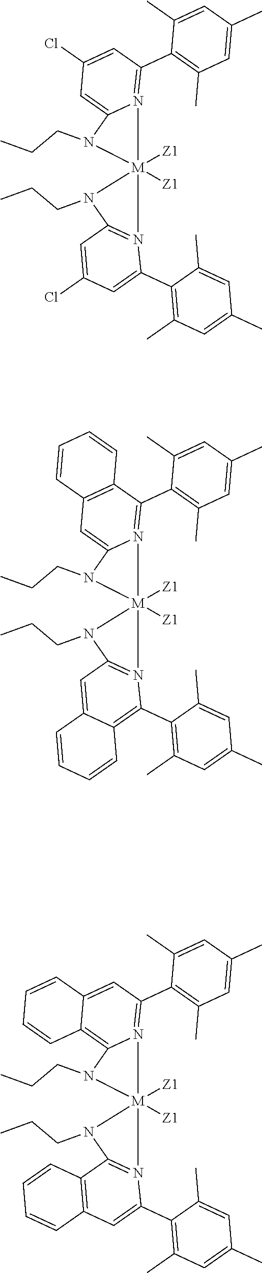

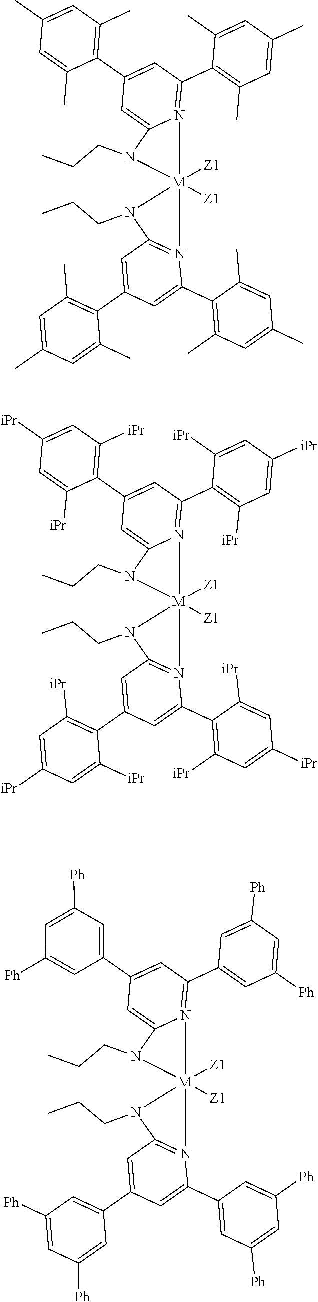

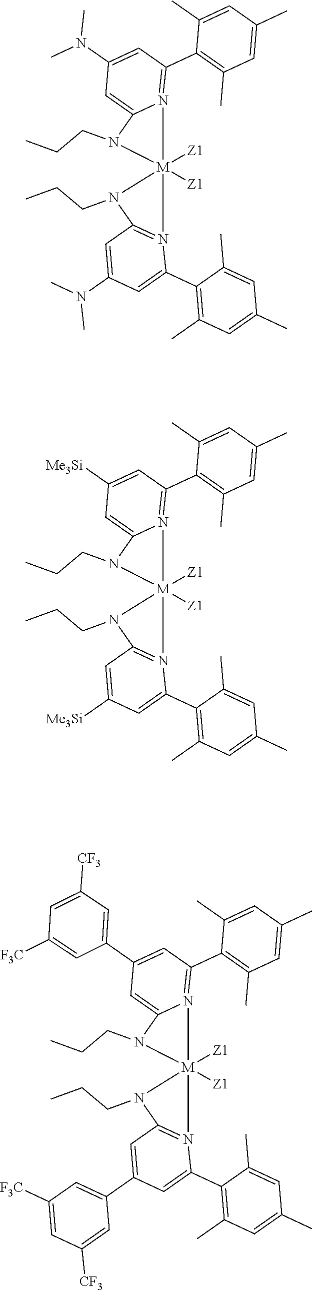

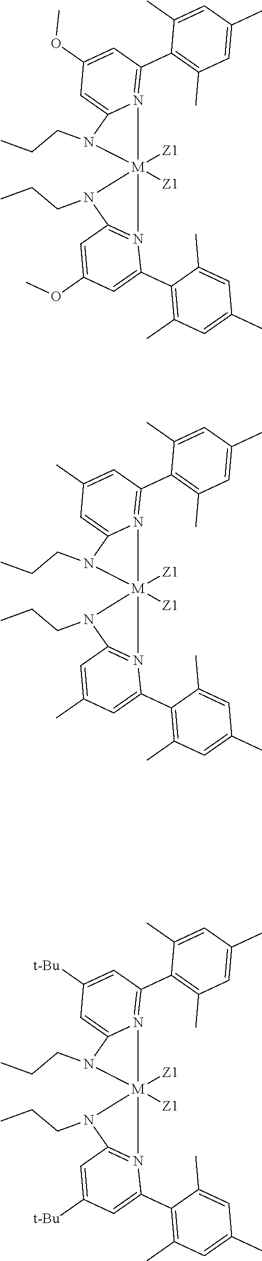

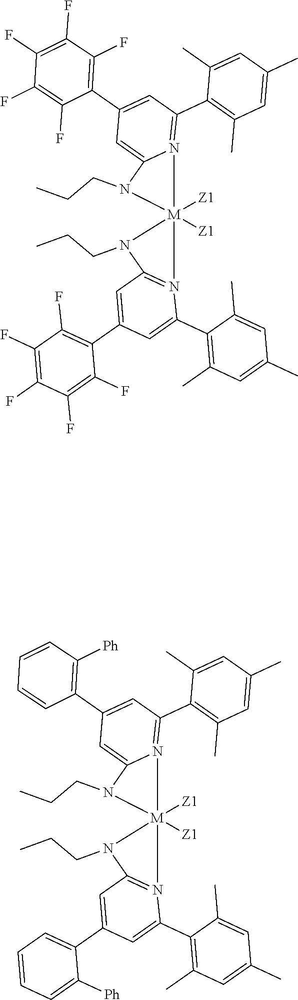

Suitable procatalysts include but are not limited to the following structures labeled as procatalysts (A1) to (A8):

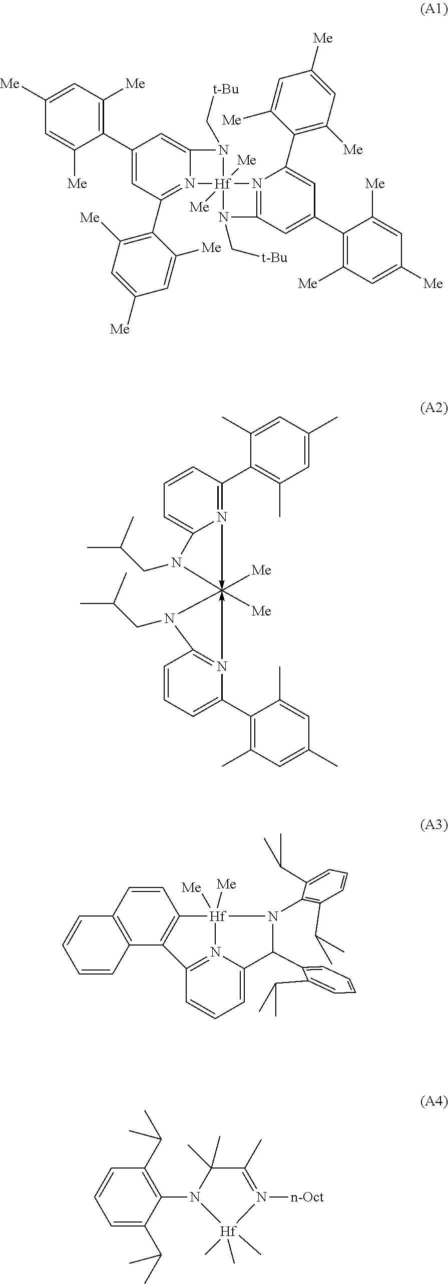

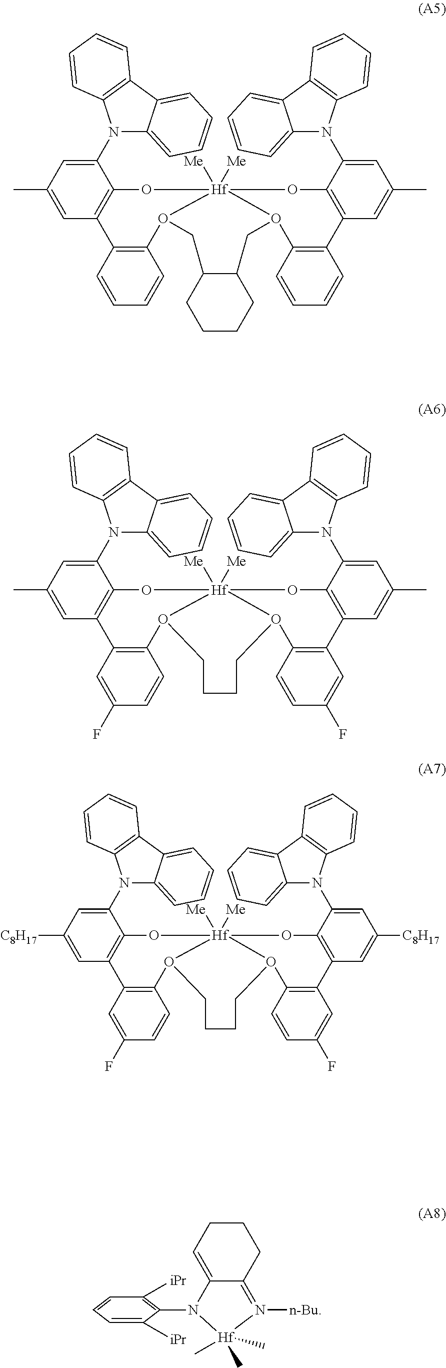

Procatalysts (A1) and (A2) may be prepared according to the teachings of WO 2017/173080 A1 or by methods known in the art. Procatalyst (A3) may be prepared according to the teachings of WO 03/40195 and U.S. Pat. No. 6,953,764 B2 or by methods known in the art. Procatalyst (A4) may be prepared according to the teachings of Macromolecules (Washington, D.C., United States), 43(19), 7903-7904 (2010) or by methods known in the art. Procatalysts (A5), (A6), and (A7) may be prepared according to the teachings of WO 2018/170138 A1 or by methods known in the art. Procatalyst (A8) may be prepared according to the teachings of WO 2011/102989 A1 or by methods known in the art.

### (D) Activator

The activator may be any compound or combination of compounds capable of activating a procatalyst to form an active catalyst composition or system. Suitable activators include but are not limited to Brøsnsted acids, Lewis acids, carbocationic species, or any activator known in the art, including but limited to those disclosed in WO 2005/090427 and U.S. Pat. No. 8,501,885 B2. In exemplary embodiments of the present disclosure, the co-catalyst is [(C₁₆₋₁₈H₃₃₋₃₇)₂CH₃NH] tetrakis(pentafluorophenyl)borate salt.

### (E) Solvent

Starting material (E) of the present process may optionally be used in step 1) of the process described above. The solvent may be a hydrocarbon solvent such as an aromatic solvent or an isoparaffinic hydrocarbon solvent. Suitable solvents include but are not limited to a non-polar aliphatic or aromatic hydrocarbon solvent selected from the group of pentane, hexane, heptane, octane, nonane, decane, undecane, dodecane, cyclopentane, methylcyclopentane, cyclohexane, methylcyclohexane, cycloheptane, cyclooctane, decalin, benzene, toluene, xylene, an isoparaffinic fluid including but not limited to Isopar™ E, Isopar™ G, Isopar™ H, Isopar™ L, Isopar™ M, a dearomatized fluid including but not limited to Exxsol™ D or isomers and mixtures of two or more thereof. Alternatively, the solvent may be toluene and/or Isopar™ E. The amount of solvent added depends on various factors including the type of solvent selected and the process conditions and equipment that will be used.

### Product and Polymerization

The present process described herein results in a silicon-terminated organo-metal composition comprising a compound of formula (I):

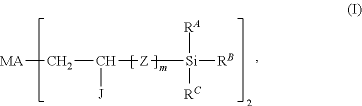

wherein:

MA is a divalent metal selected from the group consisting of Zn, Mg, and Ca;

each Z is independently a substituted or unsubstituted divalent C₁ to C₂₀ hydrocarbyl group that is linear, branched, or cyclic;

each subscript m is a number from 1 to 100,000;

each J is independently a hydrogen atom or a monovalent C₁ to C₂ hydrocarbyl group;

each R^{A}, R^{B}, and R^{C} is independently a hydrogen atom, a substituted or unsubstituted C₁ to C₁₀ monovalent hydrocarbyl group that is linear, branched, or cyclic, a vinyl group, an alkoxy group, or one or more siloxy units selected from M, D, and T units:

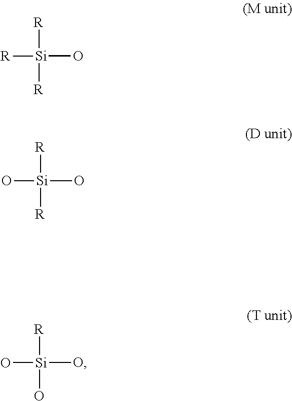

wherein each R is independently a hydrogen atom, a substituted or unsubstituted C₁ to C₁₀ monovalent hydrocarbyl group that is linear, branched, or cyclic, a vinyl group, or an alkoxy group;

two or all three of R^{A}, R^{B}, and R^{C} of one silicon atom may optionally be bonded together to form a ring structure when two or all three of R^{A}, R^{B}, and R^{C} of one silicon atom are each independently one or more siloxy units selected from D and T units.

In certain embodiments of formula (I), MA is Zn. In certain embodiments, each subscript m is a number from 1 to 75,000, from 1 to 50,000, from 1 to 25,000, from 1 to 15,000, from 1 to 10,000, from 1 to 5,000, from 1 to 2,500, or from 1 to 1,000. In certain embodiments, each J is a monovalent C₁ to C₂₀ hydrocarbyl group, such as an ethyl group. In certain embodiments, each Z is an unsubstituted C1 to C10 divalent hydrocarbyl group that is linear.

In certain embodiments, at least one of R^{A}, R^{B}, and R^{C} of each silicon atom may be a hydrogen atom or a vinyl group. In further embodiments, each of at least two of R^{A}, R^{B}, and R^{C} of each silicon atom may be a linear C₁ to C₁₀ monovalent hydrocarbyl group. In further embodiments, each of at least two of R^{A}, R^{B}, and R^{C} of each silicon atom may be a methyl group.

Examples of the —SiR^{A}R^{B}R^{C} groups of the compounds of formulas (I) and (II) include but are not limited to the following, where the squiggly line [symbol] denotes the attachment of the group to the Z group of the compound of formula (I).

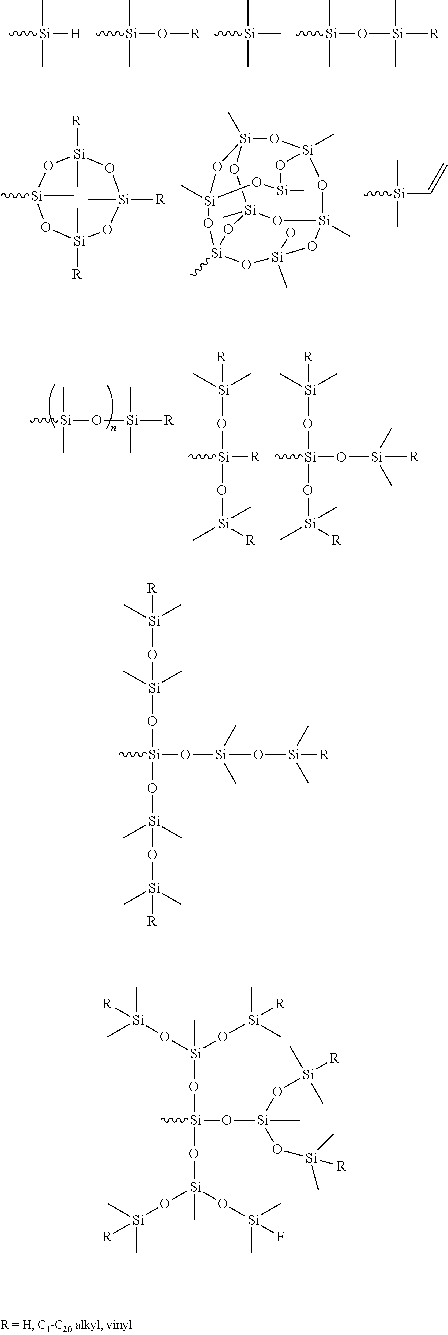

In further embodiments, the process for preparing the silicon-terminated organo-metal composition of the present disclosure may be followed by a subsequent polymerization step to form a silicon terminated polymeryl-metal, which still falls under the definition of the silicon-terminated organo-metal composition of the present disclosure. Specifically, the silicon-terminated organo-metal of the present disclosure may be combined with a procatalyst as defined herein, an activator as defined herein, at least one olefin monomer, and optional materials, such as solvents and/or scavengers. Such a polymerization step will be performed under polymerization process conditions known in the art, including but not limited to those disclosed in U.S. Pat. Nos. 7,858,706 and 8,053,529. Such a polymerization step essentially increases the subscript m in the formula (I).

Suitable monomers for the polymerization step include any addition polymerizable monomer, generally any olefin or diolefin monomer. Suitable monomers can be linear, branched, acyclic, cyclic, substituted, or unsubstituted. In one aspect, the olefin can be any α-olefin, including, for example, ethylene and at least one different copolymerizable comonomer, propylene and at least one different copolymerizable comonomer having from 4 to 20 carbons, or 4-methyl-1-pentene and at least one different copolymerizable comonomer having from 4 to 20 carbons. Examples of suitable monomers include, but are not limited to, straight-chain or branched α-olefins having from 2 to 30 carbon atoms, from 2 to 20 carbon atoms, or from 2 to 12 carbon atoms. Specific examples of suitable monomers include, but are not limited to, ethylene, propylene, 1-butene, 1-pentene, 3-methyl-1-butene, 1-hexane, 4-methyl-1-pentene, 3-methyl-1-pentene, 1-octene, 1-decene, 1-dodecene, 1-tetradecene, 1-hexadecene, 1-octadecene, and 1-eicosene. Suitable monomers also include cycloolefins having from 3 to 30, from 3 to 20 carbon atoms, or from 3 to 12 carbon atoms. Examples of cycloolefins that can be used include, but are not limited to, cyclopentene, cycloheptene, norbornene, 5-methyl-2-norbornene, tetracyclododecene, and 2-methyl-1,4,5,8-dimethano-1,2,3,4,4a,5,8,8a-octahydronaphthalene. Suitable monomers also include di- and poly-olefins having from 3 to 30, from 3 to 20 carbon atoms, or from 3 to 12 carbon atoms. Examples of di- and poly-olefins that can be used include, but are not limited to, butadiene, isoprene, 4-methyl-1,3-pentadiene, 1,3-pentadiene, 1,4-pentadiene, 1,5-hexadiene, 1,4-hexadiene, 1,3-hexadiene, 1,3-octadiene, 1,4-octadiene, 1,5-octadiene, 1,6-octadiene, 1,7-octadiene, ethylidene norbornene, vinyl norbornene, dicyclopentadiene, 7-methyl-1,6-octadiene, 4-ethylidene-8-methyl-1,7-nonadiene, and 5,9-dimethyl-1,4,8-decatriene. In a further aspect, aromatic vinyl compounds also constitute suitable monomers for preparing the copolymers disclosed here, examples of which include, but are not limited to, mono- or poly-alkylstyrenes (including styrene, o-methylstyrene, m-methylstyrene, p-methylstyrene, o,p-dimethylstyrene, o-ethylstyrene, m-ethylstyrene and p-ethylstyrene), and functional group-containing derivatives, such as methoxystyrene, ethoxystyrene, vinylbenzoic acid, methyl vinylbenzoate, vinylbenzyl acetate, hydroxystyrene, o-chlorostyrene, p-chlorostyrene, divinylbenzene, 3-phenylpropene, 4-phenylpropene and α-methylstyrene, vinylchloride, 1,2-difluoroethylene, 1,2-dichloroethylene, tetrafluoroethylene, and 3,3,3-trifluoro-1-propene, provided the monomer is polymerizable under the conditions employed.

Silicon-terminated organo-metals prepared as described above followed by a polymerization step include but are not limited to silicon-terminated-di-polyethylene zinc, silicon-terminated-di-poly(ethylene/octene) zinc, and mixtures thereof.

Any subsequent polymerization step to prepare the silicon-terminated organo-metal composition of the present disclosure may be followed by hydrolysis or use of alcohol to remove the metal resulting in a silicon-terminated polymer.

In certain embodiments, the silicon-terminated organo-metal compositions of the present disclosure may have an Mn from 1,000 g/mol to 1,000,000 g/mol, or from 1,000 g/mol to 500,000 g/mol, or from 1,000 g/mol to 250,000 g/mol, or from 1,000 g/mol to 100,000 g/mol, or from 1,000 g/mol to 50,000 g/mol, or from 1,000 g/mol to 30,000 g/mol according to methods described herein or known in the art.

The silicon-terminated organo-metal composition may include any or all embodiments disclosed herein.

### INDUSTRIAL APPLICABILITY

The present disclosure and below examples show inventive processes for preparing inventive silicon-terminated organo-metal compositions. These inventive silicon-terminated organo-metal compositions may be used in a variety of commercial applications, including facilitation of further functionalization or preparation of subsequent polymers, such as telechelic polymers.

### Definitions

All references to the Periodic Table of the Elements refer to the Periodic Table of the Elements published and copyrighted by CRC Press, Inc., 1990. Also, any references to a Group or Groups shall be to the Group or Groups reflected in this Periodic Table of the Elements using the IUPAC system for numbering groups. Unless stated to the contrary, implicit from the context, or customary in the art, all parts and percentages are based on weight and all test methods are current as of the filing date of this disclosure. For purposes of United States patent practice, the contents of any referenced patent, patent application or publication are incorporated by reference in their entirety (or its equivalent U.S. version is so incorporated by reference in its entirety), especially with respect to the disclosure of synthetic techniques, product and processing designs, polymers, catalysts, definitions (to the extent not inconsistent with any definitions specifically provided in this disclosure), and general knowledge in the art.

Number ranges in this disclosure are approximate and, thus, may include values outside of the ranges unless otherwise indicated. Number ranges include all values from and including the lower and the upper values, including fractional numbers or decimals. The disclosure of ranges includes the range itself and also anything subsumed therein, as well as endpoints. For example, disclosure of a range of 1 to 20 includes not only the range of 1 to 20 including endpoints, but also 1, 2, 3, 4, 6, 10, and 20 individually, as well as any other number subsumed in the range. Furthermore, disclosure of a range of, for example, 1 to 20 includes the subsets of, for example, 1 to 3, 2 to 6, 10 to 20, and 2 to 10, as well as any other subset subsumed in the range.

Similarly, the disclosure of Markush groups includes the entire group and also any individual members and subgroups subsumed therein. For example, disclosure of the Markush group a hydrogen atom, an alkyl group, an alkenyl group, or an aryl group, includes the member alkyl individually; the subgroup hydrogen, alkyl and aryl; the subgroup hydrogen and alkyl; and any other individual member and subgroup subsumed therein.

In the event the name of a compound herein does not conform to the structural representation thereof, the structural representation shall control.

The term “comprising” and derivatives thereof means including and is not intended to exclude the presence of any additional component, starting material, step or procedure, whether or not the same is disclosed therein.

The terms “group,” “radical,” and “substituent” are also used interchangeably in this disclosure.

The term “hydrocarbyl” means groups containing only hydrogen and carbon atoms, where the groups may be linear, branched, or cyclic, and, when cyclic, aromatic or non-aromatic.

The term “substituted” means that a hydrogen group has been replaced with a hydrocarbyl group, a heteroatom, or a heteroatom containing group. For example, methyl cyclopentadiene (Cp) is a Cp group substituted with a methyl group and ethyl alcohol is an ethyl group substituted with an —OH group.

“Catalyst precursors” include those known in the art and those disclosed in WO 2005/090426, WO 2005/090427, WO 2007/035485, WO 2009/012215, WO 2014/105411, U.S. Patent Publication Nos. 2006/0199930, 2007/0167578, 2008/0311812, and U.S. Pat. Nos. 7,355,089 B2, 8,058,373 B2, and 8,785,554 B2, all of which are incorporated herein by reference in their entirety. The terms “transition metal catalysts,” “transition metal catalyst precursors,” “catalysts,” “catalyst precursors,” “polymerization catalysts or catalyst precursors,” “procatalysts,” “metal complexes,” “complexes,” “metal-ligand complexes,” and like terms are to be interchangeable in the present disclosure.

“Co-catalyst” refers to those known in the art, e.g., those disclosed in WO 2005/090427 and U.S. Pat. No. 8,501,885 B2, that can activate the catalyst precursor to form an active catalyst composition. “Activator” and like terms are used interchangeably with “co-catalyst.”

The term “catalyst system,” “active catalyst,” “activated catalyst,” “active catalyst composition,” “olefin polymerization catalyst,” and like terms are interchangeable and refer to a catalyst precursor/co-catalyst pair. Such terms can also include more than one catalyst precursor and/or more than one activator and optionally a co-activator. Likewise, these terms can also include more than one activated catalyst and one or more activator or other charge-balancing moiety, and optionally a co-activator.

The terms “polymer,” “polymer,” and the like refer to a compound prepared by polymerizing monomers, whether of the same or a different type. The generic term polymer thus embraces the term homopolymer, usually employed to refer to polymers prepared from only one type of monomer, and the term interpolymer as defined below. It also embraces all forms of interpolymers, e.g., random, block, homogeneous, heterogeneous, etc.

“Interpolymer” and “copolymer” refer to a polymer prepared by the polymerization of at least two different types of monomers. These generic terms include both classical copolymers, i.e., polymers prepared from two different types of monomers, and polymers prepared from more than two different types of monomers, e.g., terpolymers, tetrapolymers, etc.

### EXAMPLES

### Methods

¹H NMR:

¹H NMR spectra are recorded on a Bruker AV-400 spectrometer at ambient temperature. ¹H NMR chemical shifts in benzene-d₆ are referenced to 7.16 ppm (C₆D₅H) relative to TMS (0.00 ppm).

¹³C NMR:

¹³C NMR spectra of polymers are collected using a Bruker 400 MHz spectrometer equipped with a Bruker Dual DUL high-temperature CryoProbe. The polymer samples are prepared by adding approximately 2.6 g of a 50/50 mixture of tetrachloroethane-d₂/orthodichlorobenzene containing 0.025M chromium trisacetylacetonate (relaxation agent) to 0.2 g of polymer in a 10 mm NMR tube. The samples are dissolved and homogenized by heating the tube and its contents to 150° C. The data is acquired using 320 scans per data file, with a 7.3 second pulse repetition delay with a sample temperature of 120° C.

GC/MS:

Tandem gas chromatography/low resolution mass spectroscopy using electron impact ionization (EI) is performed at 70 eV on an Agilent Technologies 6890N series gas chromatograph equipped with an Agilent Technologies 5975 inert XL mass selective detector and an Agilent Technologies Capillary column (HP1MS, 15 m×0.25 mm, 0.25 micron) with respect to the following:

### Programmed Method:

| | |
|---|---|
| Oven Equilibration Time | 0.5 min |
| 50° C. for 0 min | |
| then 25° C./min to 200° C. for 5 min | |
| Run Time | 11 min |

GPC:

The gel permeation chromatographic system consists of either a Polymer Laboratories Model PL-210 or a Polymer Laboratories Model PL-220 instrument. The column and carousel compartments are operated at 140° C. Three Polymer (Laboratories 10-micron Mixed-B columns are used. The solvent is 1,2,4 trichlorobenzene. The samples are prepared at a concentration of 0.1 grams of polymer in 50 milliliters of solvent containing 200 ppm of butylated hydroxytoluene (BHT). Samples are prepared by agitating lightly for 2 hours at 160° C. The injection volume used is 100 microliters and the flow rate is 1.0 ml/minute.

Calibration of the GPC column set is performed with 21 narrow molecular weight distribution polystyrene standards with molecular weights ranging from 580 to 8,400,000, arranged in 6 “cocktail” mixtures with at least a decade of separation between individual molecular weights. The standards are purchased from Polymer Laboratories (Shropshire, UK). The polystyrene standards are prepared at 0.025 grams in 50 milliliters of solvent for molecular weights equal to or greater than 1,000,000 and 0.05 grams in 50 milliliters of solvent for molecular weights less than 1,000,000. The polystyrene standards are dissolved at 80° C. with gentle agitation for 30 minutes. The narrow standards mixtures are run first and in order of decreasing highest molecular weight component to minimize degradation. The polystyrene standard peak molecular weights are converted to polyethylene molecular weights using the following equation (as described in Williams and Ward, J. Polym. Sci., Polym. Let., 6, 621 (1968)): M_{polyethylene}=0.431(M_{polystyrene}). Polyethylene equivalent molecular weight calculations are performed using Viscotek TriSEC software Version 3.0.

Molecular Weight:

Molecular weights are determined by optical analysis techniques including deconvoluted gel permeation chromatography coupled with a low angle laser light scattering detector (GPC-LALLS) as described by Rudin, A., “Modern Methods of Polymer Characterization”, John Wiley & Sons, New York (1991) pp. 103-112.

Unless noted otherwise, all starting materials for the examples described below are commercially available from, for example, Sigma-Aldrich and Gelest.

The starting material 7-octenyldimethylvinylsilane or dimethyl(oct-7-en-1-yl)(vinyl)silane used in the examples below is prepared according to Reaction Scheme X and as follows. In a glovebox under nitrogen atmosphere, a 250 mL flask is charged with SilylChloride (3.13 ml, 12.21 mmol) in anhydrous THF 25 mL. 1M VinylMgBr in THF (8 ml) is then added slowly over 10 minutes (temperature increased to 22.8° C., internal monitoring using thermocouple). The second portion of the 1M VinylMgBr in THF (8 ml) is then added slowly over 10 minutes (temperature increased to 25° C.). The reaction is then stirred for 16 h. After this time, the flask is removed from the glove box and the reaction mixture is quenched with sat. aq. NaHCO3 (10 mL, first few drops added slowly as gas evolved) then water (10 mL) is added. The mixture is transferred to a separatory funnel, Et2O is added (30 mL), the layers are separated, and the organic phase is further washed with sat. aq. NaHCO3 (10 mL), water (10 mL), brine (10 mL), dried (Na2SO4), filtered, then concentrated to dryness. The concentrate is passed through a plug of silica gel, eluting with hexanes (40 mL). This solution is concentrated to dryness then taken into the glovebox. The product is taken up in hexanes (8 mL) then anhydrous Na2SO4 is added. The solution is filtered through a fritted funnel into a 40 mL vial. The Na2SO4 is further extracted with hexanes (2×4 mL). The hexanes are removed under reduced pressure to provide 2.3 g (95.9%) of product as a colorless liquid.

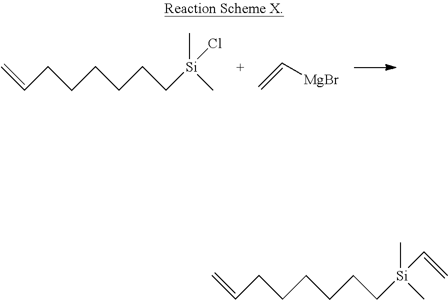

### Example 1

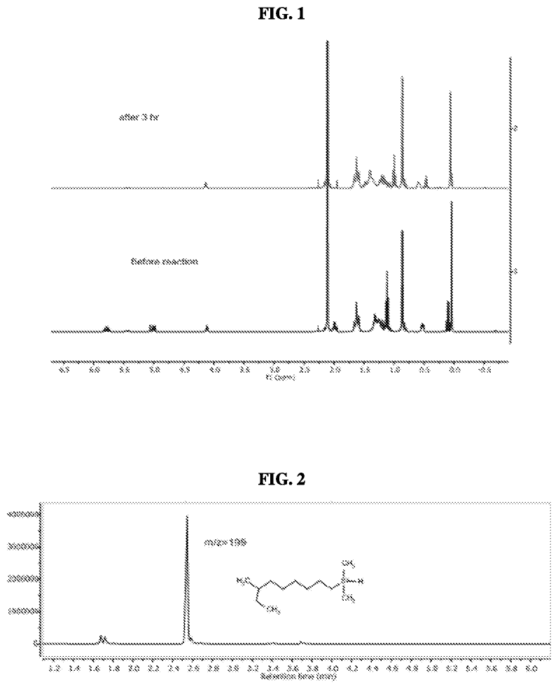

Synthesis of bis(8-(dimethylsilyl)-2-ethyloctyl)zinc. An exemplary silicon-terminated organo-metal composition is prepared as follows and as seen in Reaction Scheme 1. In a nitrogen-filled drybox, 7-octenyldimethylsilane (0.33 g, 1.94 mmol), MAO (0.22 mL of 30 wt % solution in toluene, 0.065 mmol A1), diethylzinc (0.1 mL, 0.97 mmol) and activator [(C₁₆₋₁₈H₃₃₋₃₇)₂CH₃NH] tetrakis(pentafluorophenyl)borate salt (Act. A) available from Boulder Scientific (0.48 mL of 0.064M solution in methylcyclohexane, 0.031 mmol) are added to 3 ml of toluene. Procatalyst (A4) as defined above (PCA in Reaction Scheme 1) (12 mg, 0.026 mmol) is dissolved in 1 mL toluene and added to the mixture to initiate the reaction. After 3 hr, NMR (FIG. 1) shows that the vinyl groups are completely consumed. The remaining peak at 4.2 ppm is believed to be octenylsilane isomers with unreactive internal double bonds. One aliquot is quenched with H₂O for GCMS analysis (FIG. 2) showing a major product peak at 199.2, which is consistent with the expected hydrolyzed product. The small peaks at 1.7 min elution time belong to the unreacted octenylsilane isomers as mentioned.

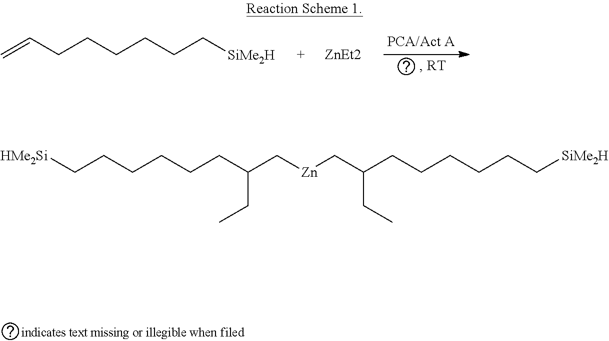

### Example 2

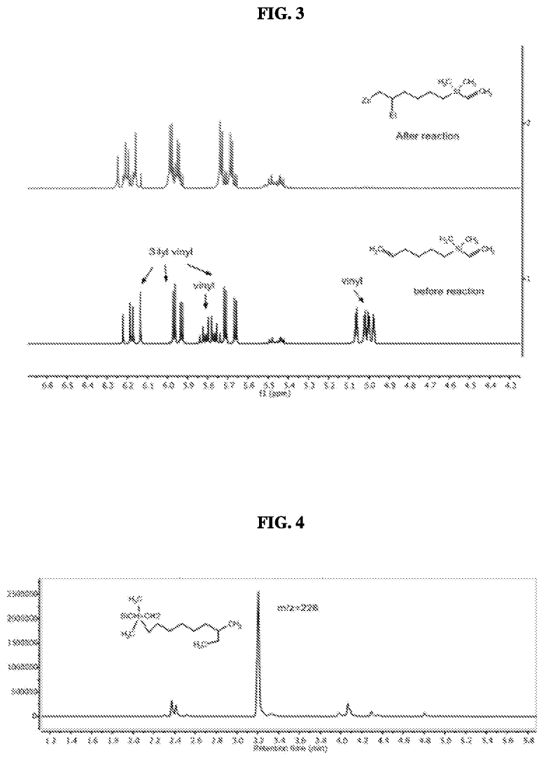

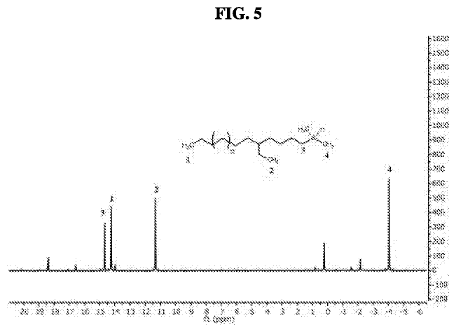

Synthesis of bis(8-(dimethyl(vinyl)silyl)-2-ethyloctyl)zinc. An exemplary silicon-terminated organo-metal composition is prepared as follows and as seen in Reaction Scheme 2. In the drybox under nitrogen atmosphere, 7-octenyldimethylvinylsilane (0.38 g, 1.94 mmol), diethylzinc (0.1 mL, 0.97 mmol) and Act. A (0.48 mL of 0.064M solution in methylcyclohexane, 0.031 mmol) are added to 3 ml of toluene. PCA (Procatalyst (A4) (12 mg, 0.026 mmol)) is dissolved in 0.5 mL toluene and added to initiate the reaction. After 1.5 hr, NMR (FIG. 3) shows that the olefinic vinyl groups were completely consumed while the silylvinyl groups remained. The remaining peak at 4.2 ppm is believed to be octenylsilane isomers with unreactive internal double bonds. One aliquot is quenched with H₂O for GCMS analysis (FIG. 4) showing a major product peak at m/z of 226, which is consistent to the molecular weight of the expected hydrolyzed product. The small peaks at 2.4 min elution time were believed to be the unreacted octenylsilane isomers with internal or vinylidene double bonds.

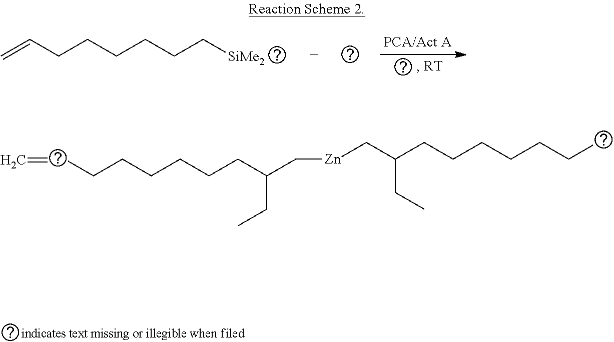

### Example 3—Ethylene Polymerization

Subsequent ethylene polymerization of the silicon-terminated organo-metal prepared in Example 1 is performed as follows and as seen in Reaction Scheme 3. In a nitrogen-filled drybox, a 40 mL scintillation vial equipped with a stirbar is charged with 10 ml of ISOPAR-E and Act. A (0.04 mL of 0.064M solution in MCH, 0.0026 mmol). The vial is capped with a septum lined lid and placed in a heating block. Connected to C2 line and slowly purge the vial a needle. Once the temp is reached, bis(8-(dimethylsilyl)-2-ethyloctyl)zinc (1 mL, 0.2 mmol) and PCA (Procatalyst (A4) (0.002 mmol Hf)) are injected and the purge needle is removed to maintain a total pressure at 12 psig. The reaction is maintained for 30 min, then quenched by MeOH. Filtered and dried under vacuum at RT overnight to obtain 0.48 g of white polyethylene solid. 13C NMR (FIG. 5) confirms the polymer structure with terminal SiMe2H group.

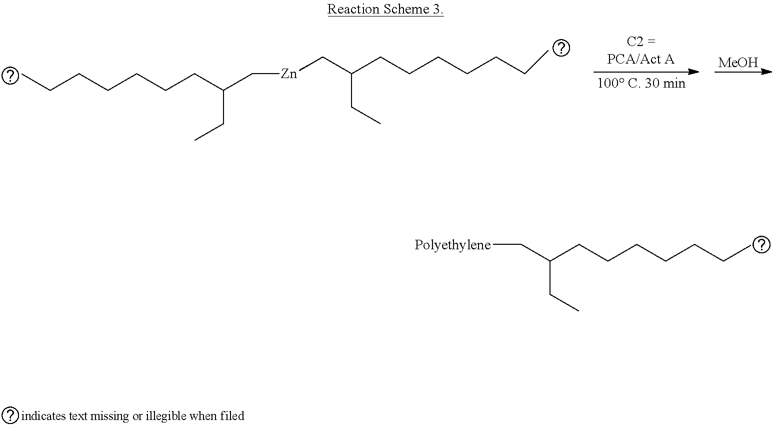

What is claimed is:

1. A silicon-terminated organo-metal composition comprising a compound of formula (I): 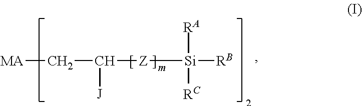
wherein:
MA is a divalent metal selected from the group consisting of Zn, Mg, and Ca;
each Z is independently a substituted or unsubstituted divalent C₁ to C₂ hydrocarbyl group that is linear, branched, or cyclic;
each subscript m is a number from 1 to 100,000;
each J is independently a hydrogen atom or a monovalent C₁ to C₂ hydrocarbyl group;
each R^{A}, R^{B}, and R^{C} is independently a hydrogen atom, a substituted or unsubstituted C₁ to C₁₀ monovalent hydrocarbyl group that is linear, branched, or cyclic, a vinyl group, an alkoxy group, or one or more siloxy units selected from M, D, and T units: 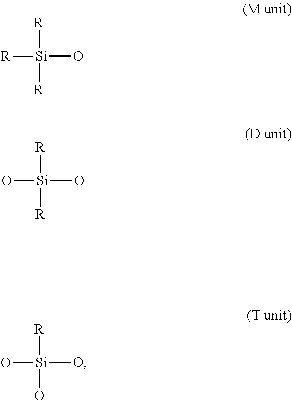
wherein each R is independently a hydrogen atom, a substituted or unsubstituted C₁ to C₁₀ monovalent hydrocarbyl group that is linear, branched, or cyclic, a vinyl group, or an alkoxy group;
two or all three of R^{A}, R^{B}, and R^{C} of one silicon atom may optionally be bonded together to form a ring structure when two or all three of R^{A}, R^{B}, and R^{C} of one silicon atom are each independently one or more siloxy units selected from D and T units.

2. The composition of claim 1, wherein MA is Zn.

3. The composition of claim 1, wherein each J is a monovalent C₁ to C₂ hydrocarbyl group.

4. The composition of claim 3, wherein each J is an ethyl group.

5. The composition of claim 1, wherein each Z is an unsubstituted divalent C₁ to C₁₀ hydrocarbyl group that is linear.

6. The composition of claim 1, wherein each subscript m is a number from 1 to 1,000.

7. The composition of claim 1, wherein at least one of R^{A}, R^{B}, and R^{C} of each silicon atom is a hydrogen atom or a vinyl group.

8. The composition of claim 1, wherein each of at least two of R^{A}, R^{B}, and R^{C} of each silicon atom is a linear C₁ to C₁₀ monovalent hydrocarbyl group.

9. The composition of claim 8, wherein each of at least two of R^{A}, R^{B}, and R^{C} of each silicon atom is a methyl group.

10. A process for preparing a silicon-terminated organo-metal composition, the process comprising 1) combining starting materials comprising (A) a vinyl-terminated silicon-based compound, (B) a chain shuttling agent, (C) a procatalyst, and (D) an activator, thereby obtaining a product comprising the silicon-terminated organo-metal composition.

11. The process of claim 10, wherein the starting materials further comprise (E) a solvent and (F) a scavenger.

12. The process of claim 10, wherein the (A) vinyl-terminated silicon-based compound has the formula (II): 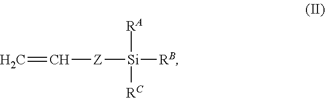
wherein:
Z is a substituted or unsubstituted divalent C₁ to C₂₀ hydrocarbyl group that is linear, branched, or cyclic;
R^{A}, R^{B}, and R^{C} are each independently a hydrogen atom, a substituted or unsubstituted C₁ to C₁₀ monovalent hydrocarbyl group that is linear, branched, or cyclic, a vinyl group, an alkoxy group, or one or more siloxy units selected from M, D, and T units: 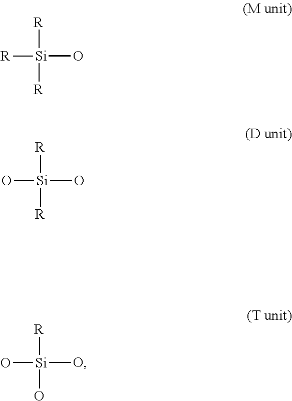
wherein each R is independently a hydrogen atom, a substituted or unsubstituted C₁ to C₁₀ monovalent hydrocarbyl group that is linear, branched, or cyclic, a vinyl group, or an alkoxy group; and
two or all three of R^{A}, R^{B}, and R^{C} may optionally be bonded together to form a ring structure when two or all three of R^{A}, R^{B}, and R^{C} are each independently one or more siloxy units selected from D and T units.

13. The process of claim 12, wherein Z is an unsubstituted divalent C₁ to C₁₀ hydrocarbyl group that is linear.

14. The process of claim 12, wherein at least one of R^{A}, R^{B}, and R^{C} is a hydrogen atom or a vinyl group.

15. The process of claim 12, wherein each of at least two of R^{A}, R^{B}, and R^{C} is a linear C₁ to C₁₀ monovalent hydrocarbyl group.

16. The process of claim 15, wherein each of at least two of R^{A}, R^{B}, and R^{C} is a methyl group.

17. The process of claim 10, wherein the vinyl-terminated silicon-based compound is selected from the group consisting of 7-octenyldimethylsilane, 7-octenyldimethylvinylsilane, and mixtures thereof.

18. The process of claim 10, wherein the (B) chain shuttling agent has the formula Y₂MA, where MA is Zn, and each Y is independently a hydrocarbyl group of 1 to 20 carbon atoms.

19. The process of claim 10, wherein the (C) procatalyst is selected from the group consisting of procatalysts (A1) to (A8):

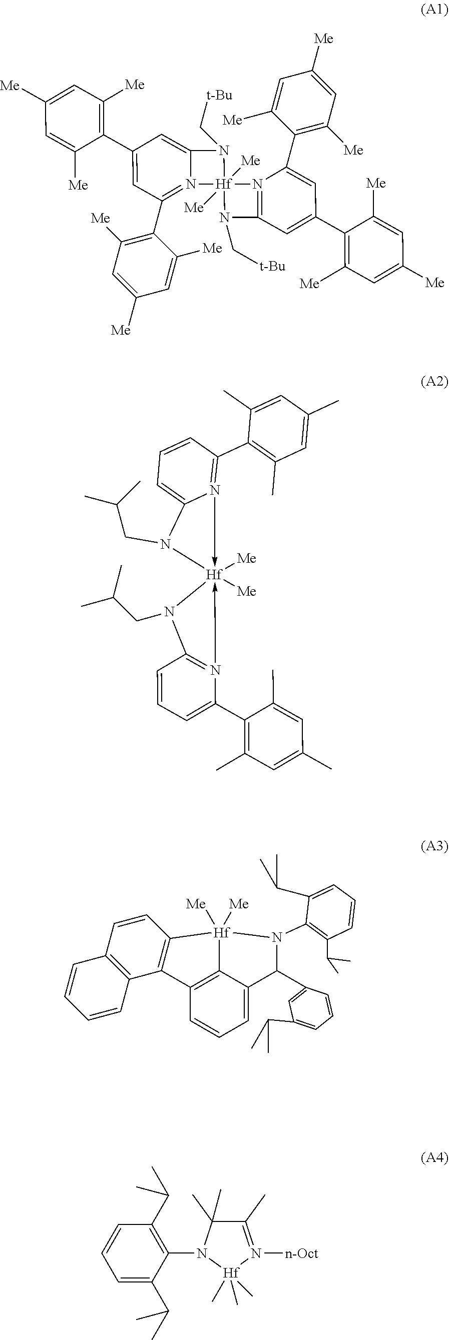

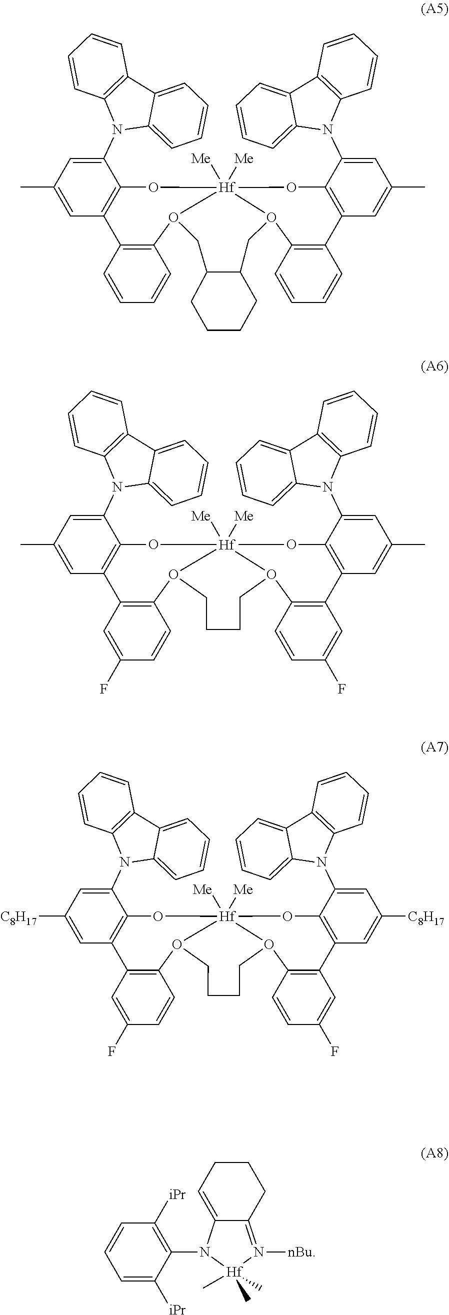

20. The process of claim 10, wherein the process, after step 1), further comprises forming a silicon-terminated polymeryl-metal by a process comprising combining starting materials comprising:
i) the silicon-terminated organo-metal composition of any of claims 1 to 9,
ii) a procatalyst,
iii) an activator,
iv) at least one olefin monomer, and
v) an optional solvent.
